(19) United States
(12) Patent Application Publication
(10) Pub. No.: US 2010/0195460 A1
(43) Pub. Date: Aug. 5, 2010

(54) OPTICAL WRITING APPARATUS, IMAGE FORMING APPARATUS AND DATA WRITING METHOD

(76) Inventor: Takashi HASEBE, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/694,468

(22) Filed: Jan. 27, 2010

(30) Foreign Application Priority Data
Jan. 30, 2009 (JP) 2009-020003

(51) Int. Cl. G11B 20/10; G11B 7/00

(52) U.S. Cl. 369/47.14; 369/112.23; G9B/7

(57) ABSTRACT

An optical writing apparatus includes: a light source section having a plurality of light emitting elements arrayed in a main scanning direction; an optical section having a plurality of imaging lenses that condense irradiated light from the light emitting elements to form an image on an exposure surface; and a storage section. The storage section stores: first correction data including light amount correction values for correcting amounts of light of the respective light emitting elements; and second correction data. The second correction data includes: local correction target position information in an array direction of the light emitting elements that is calculated based on optical characteristics data specific to the imaging lenses; and a correction reference value for correcting one or more of the light amount correction values of one or more of the light emitting elements arrayed at local positions indicated by the correction target position information.

### BACKGROUND OF THE INVENTION

1. Field of the Invention

The present invention relates to an optical writing apparatus, an image forming apparatus and a data writing method.

2. Description of Related Art

In recent years, an image forming apparatus has been developed that uses an LED printer head (hereunder, referred to as “LPH”) as an optical writing apparatus that forms an electrostatic latent image on a surface of a photosensitive body. The LPH includes an LED chip array and a lens array. In the LED chip array, LED chips that include a plurality of LED (Light Emitting Diode) elements arranged in accordance with a previously set resolution along a main scanning direction are arranged in array. In the lens array, a plurality of GRIN (graded-index) lenses are arranged. The GRIN lenses collects irradiated light from the LED elements which emit light in accordance with image data to form an electrostatic latent image on a photosensitive body.

It is known that light quantity unevenness occurs in an image forming apparatus that uses an LPH. The light quantity unevenness is caused by manufacturing variations in the LED elements, variations in optical characteristics due to angular variations when mounting and fixing the GRIN lenses or the refractive index distribution and the like, and adherence of dust or the like. Light quantity unevenness generates density unevenness, and there is the problem that black stripes and white stripes occur on images as a result of the density unevenness.

Japanese Patent Laid-Open No. 2006-248185 discloses an image forming apparatus that has an LPH and that specifies a position of a black stripe caused by a lens array. In order to specify the position of the black stripe, the image forming apparatus changes defocus positions in five stages in a graph of MTF characteristics for each dot to refer to changes in the MTF for each dot, and specifies a location where a variation in a beam diameter is large, that is, the location of a dip where the MTF abruptly fluctuates.

The technique of Japanese Patent Laid-Open No. 2006-248185, however, requires MTF measurement at the different defocus positions. Moreover, this document is silent as to a correcting method with respect to the specified position after specifying the position of the black stripe. Therefore, the correction cannot be made with respect to the position of the black stripe.

### SUMMARY OF THE INVENTION

It is, therefore, a main object of the present invention to specify a position of a black stripe which appears on an image due to imaging lenses constituting an optical writing apparatus, and to enable a correction of an amount of light with respect to the position of the black stripe to improve image quality.

According to a first aspect of the present invention, there is provided an optical writing apparatus which includes: a light source section having a plurality of light emitting elements arrayed in a main scanning direction; an optical section having a plurality of imaging lenses that condense irradiated light from the light emitting elements to form an image on an exposure surface; and a storage section. The storage section stores: first correction data including light amount correction values for correcting amounts of light of the respective light emitting elements; and second correction data. The second correction data includes: local correction target position information in an array direction of the light emitting elements that is calculated based on optical characteristics data specific to the imaging lenses; and

a correction reference value for correcting one or more of the light amount correction values of one or more of the light emitting elements arrayed at local positions indicated by the correction target position information.

According to a second aspect of the present invention, there is provided an image forming apparatus that forms an image using the optical writing apparatus. The image forming apparatus includes: a control section to read out the first correction data and the second correction data from the storage section of the optical writing apparatus to correct the first correction data based on the second correction data; and a main body storage section to store the first correction data corrected by the control section.

According to a third aspect of the present invention, there is provided a data writing method in a system which includes an optical writing apparatus and a control apparatus. The optical writing apparatus includes: a light source section having a plurality of light emitting elements arrayed in a main scanning direction; an optical section having a plurality of imaging lenses that condense irradiated light from the light emitting elements to form an image on an exposure surface; and a storage section. The control apparatus writes data on the storage section of the optical writing apparatus. The data writing method includes: measuring optical characteristics data specific to the imaging lenses; calculating correction data based on the optical characteristics data, the correction data including a correction reference value and local correction target position information in an array direction of the light emitting elements; and writing the correction data on the storage section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 shows a block diagram of a configuration of an LPH inspection system according to preferred embodiments of the present invention;

FIG. 2 shows a relation between an exemplary arrangement of imaging lenses in a “trefoil formation” and light emitting elements;

FIG. 3 shows a control block diagram of an image forming apparatus according to the preferred embodiments of the present invention;

FIG. 4 shows a flowchart of LPH inspection processing according to the preferred embodiments of the present invention;

FIG. 5 shows a flowchart of LPH sub-assembly inspection processing executed by the LPH inspection system;

FIG. 6 shows a flowchart of first light amount adjustment processing;

FIG. 7 shows a flowchart of second light amount adjustment processing;

FIG. 8 shows a flowchart of third light amount adjustment processing;

FIG. 9 shows a flowchart of MTF measurement processing using simplified processing with a 1 (on)-3 (off) turn-on pattern;

FIG. 10 shows a flowchart of correction data generating processing;

FIG. 11 shows a flowchart of correction data generating processing (a continuation of FIG. 10);

FIG. 12 shows an example of a maximum value list;

FIG. 13 shows an example of element numbers of light emitting elements, difference values ΔM(n), and processed difference values ΔMM(n), in a segment with a peak element number PP as its center;

FIG. 14 shows a flowchart of correction data writing processing;

FIG. 15 shows an example of a memory configuration of a storage section of an LPH;

FIG. 16 shows an exemplary format of data stored in a divided region A1 of an A bank;

FIG. 17 shows an exemplary format of data stored in a divided region B1 of a B bank;

FIG. 18 shows a flowchart of LPH assembly processing;

FIG. 19 shows a flowchart of LPH adjustment processing;

FIG. 20 shows an exemplary confirmation image on a sheet;

FIG. 21 shows an exemplary adjustment menu screen;

FIG. 22 shows an exemplary graph of light amount manipulation variables with respect to each light emitting element;

FIG. 23 shows a conceptual illustration of a correction amount when an adjustment amount is 0;

FIG. 24 shows a conceptual illustration of a correction amount when the adjustment amount is −1; and

FIG. 25 shows a conceptual illustration of a correction amount when the adjustment amount is −2.

### DESCRIPTION OF THE PREFERRED EMBODIMENTS

Preferred embodiments of the present invention will be described below in detail with reference to the drawings.

In the present embodiments, an LPH is inspected by an LPH inspection system; the LPH that has been inspected is mounted in an image forming apparatus; and light amount adjustment of the LPH is made.

First, a configuration of the present embodiment will be described.

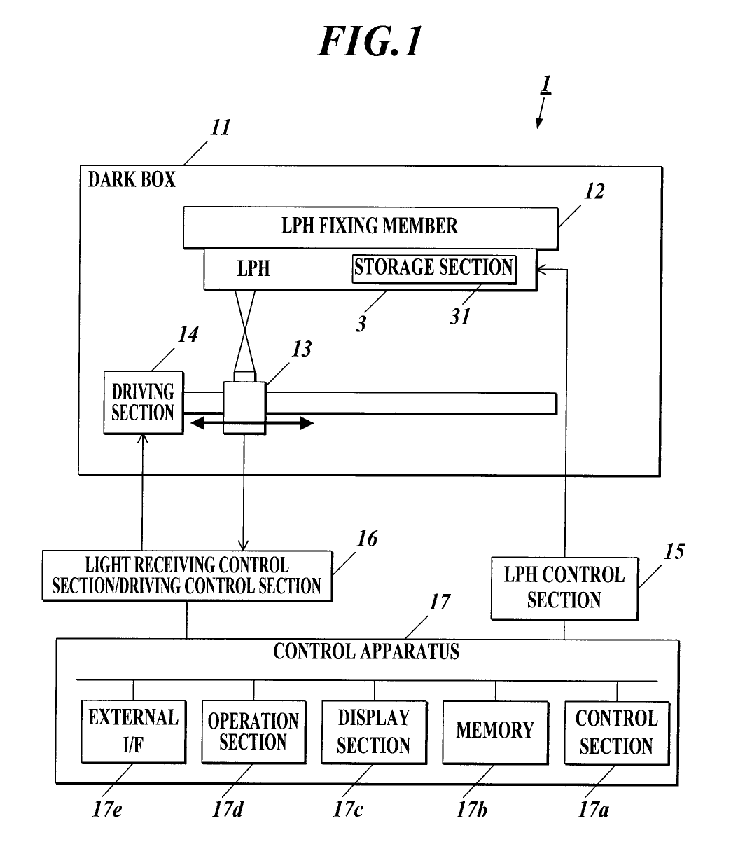

FIG. 1 shows a configuration diagram of an LPH inspection system 1 according to the present embodiment.

As shown in FIG. 1, the LPH inspection system 1 includes an LPH 3 provided inside a dark box 11, an LPH fixing member 12, a light receiving section 13, a driving section 14, an LPH control section 15, a light receiving control section/driving control section 16, and a control apparatus 17.

The LPH 3 includes a light source section and an optical section. The light source section includes an LED array comprising a plurality of light emitting elements (for example, LED (Light Emitting Diode) elements) that are arranged in a main scanning direction at a pixel pitch that corresponds to a previously set resolution. The optical section includes a lens array comprising a plurality of imaging lenses (for example, GRIN (graded-index) lenses) that condense light irradiated from the light emitting elements and form an image on an exposure surface. The LPH 3 is an optical writing apparatus in which light emitting elements are selectively driven and turned on based on image data, and which condenses light irradiated from the driven light emitting element onto an exposure surface by means of imaging lenses to form an image thereon.

Identification numbers (element numbers) are assigned to the respective light emitting elements.

The LPH 3 also includes a storage section 31. The storage section 31 is an electrically rewritable, non-volatile storage medium such as an EEPROM (Electrically Erasable and Programmable Read Only Memory) or a flash memory. A storage medium with which erasing/rewriting can be performed in predetermined storage region units is preferable as the storage section 31. The storage section 31 may be fixedly provided in the LPH 3 or may be detachably mounted therein.

LPH data of various kinds that are acquired by the LPH inspection system 1 are stored in the storage section 31. The various kinds of data include basic correction data and black stripe correction data.

The basic correction data is first correction data in which light amount correction values for correcting the amounts of light of a plurality of light emitting elements constituting the LPH 3 are tabularized in a format in which the light amount correction values are associated with the element numbers of the respective light emitting elements.

The black stripe correction data is second correction data for correcting optical characteristics specific to the imaging lenses in an array direction of the light emitting elements, calculated based on the optical characteristics data specific to the imaging lens.

The black stripe correction data includes segment information. The segment information is local correction target position information in the array direction of the light emitting element, and indicates a segment (correction target segment) in which light emitting elements are arrayed for which values of optical characteristics data change locally. The segment information specifies a light emitting element as a correction target among light amount correction values included in the basic correction data.

The black stripe correction data includes a correction reference value that serves as a reference for a correction value for correcting a light amount correction value of a light emitting element arranged at a local position that is shown by the correction target segment. The correction reference value is a maximum value (a correction peak value MP as described later) of values calculated based on optical characteristics data among light emitting elements included in the correction target segment.

The LPH fixing member 12 is, for example, a member that sucks and holds the LPH 3 by air suction and fixes the LPH 3 in a previously set position.

The light receiving section 13 receives light irradiated from the LPH 3, and outputs a light amount value for the received light to the light receiving control section/driving control section 16. As examples of the light receiving section 13, a CCD (Charge Coupled Device), a photomultiplier, a photodiode and the like may be mentioned.

The driving section 14 includes a motor and a guide rail that extends in the main scanning direction at a position facing an irradiation surface of the LPH 3, and the like. The driving section 14 maintains the light receiving section 13 at a position facing the irradiation surface of the LPH 3 on the guide rail, and moves the light receiving section 13 in the main scanning direction in accordance with an instruction from the light receiving control section/driving control section 16.

The LPH control section 15 controls the entire LPH 3 in accordance with an instruction from the control apparatus 17. The LPH control section 15 sets exposure time (lighting time) and light amount correction values of the light emitting elements as well as light emitting elements to be turned on in the LPH 3 in accordance with an instruction from the control apparatus 17. The LPH control section 15 causes the selected light emitting element to be turned on at the exposure time. The LPH control section 15 also writes various data such as basic correction data or black stripe correction data into the storage section 31 of the LPH 3 in accordance with an instruction input from the control apparatus 17.

The light receiving control section/driving control section 16 executes photoelectric conversion processing and A/D conversion processing with respect to a light amount value input from the light receiving section 13 to thereby calculate a light amount measurement value. The light receiving control section/driving control section 16 outputs the light amount measurement value to the control apparatus 17. The light receiving control section/driving control section 16 also drives the motor of the driving section in accordance with an instruction input from the control apparatus 17 to move the light receiving section 13 that is being maintained on the guide rail in the main scanning direction of the LPH 3.

The control apparatus 17 includes a control section 17a, a memory 17b, a display section 17c, an operation section 17d, an external I/F 17e and the like, and performs general control of the entire LPH inspection system 1.

The control section 17a includes a CPU (Central Processing Unit), a ROM (Read Only Memory), and a RAM (Random Access Memory). The control section 17a reads out a system program, respective processing programs, data, and the like stored in the ROM or the memory 17b, expands the programs and data and the like inside the RAM, and controls operations of each section of the control apparatus 17 in accordance with the expanded programs. The control section 17a also performs general control of the LPH control section 15 and the light receiving control section/driving control section 16, as well as general control of the entire LPH inspection system 1.

Further, the control section 17a reads out an LPH inspection program, a light amount correction table, various data, and the like that are stored in the ROM or memory 17b to execute LPH inspection processing. The LPH inspection processing includes LPH sub-assembly inspection processing, correction data generating processing, correction data writing processing.

The LPH sub-assembly inspection processing is processing that measures optical characteristics data (MTF) specific to an imaging lens to acquire optical characteristics data. The LPH sub-assembly inspection processing includes first to third light amount adjustment processing and MTF measurement processing.

The first to third light amount adjustment processing measures a light amount of the LPH and generates basic correction data.

The MTF measurement processing causes each light emitting element of the LPH to be turned on by the LPH control section 15 in a previously set turn-on pattern based on a light amount that is set in accordance with the basic correction data generated by the first to third light amount adjustment processing. Further, the MTF measurement processing causes the light receiving control section/driving control section 16 to drive the driving section 14 to move the light receiving section 13 to positions facing light emitting elements to be turned on, to thereby calculate characteristics data for each light emitting element based on light amount measurement values that are received by the light receiving section 13 and input by the light receiving control section/driving control section 16. More specifically, data is calculated that represents the resolution of the optical system as MTF characteristics (Modulation Transfer Function characteristics), which is also referred to as a “contrast transfer function”.

As a turn-on pattern for MTF measurement processing in the present embodiment, a turn-on pattern in which every fourth light emitting element is turned on (hereunder, also referred to as “1 (on)—3 (off)”) is used. Other turn-on patterns include a turn-on pattern in which every second light emitting element is turned on (hereunder, also referred to as “1 (on)—1 (off)”), and a turn-on pattern in which every second unit of two consecutive light emitting elements is turned on (hereunder, also referred to as “2 (on)—2 (off)”).

The correction data generating processing is processing that calculates local second correction data (black stripe correction data) in the array direction of the light emitting elements based on optical characteristics data, and includes first to third calculation processing.

The first calculation processing is processing that calculates a first moving average value for each light emitting element in a previously set first moving average segment as a first operation value based on characteristics data for each light emitting element.

The second calculation processing is processing that calculates a second moving average value for each light emitting element in a previously set second moving average segment that is larger than the first moving average segment as a second operation value that is different to the first operation value (first moving average value) based on characteristics data for each light emitting element.

The first moving average segment of the first calculation processing and the second moving average segment of the second calculation processing are defined based on the arrangement of the imaging lenses of the optical section of the LPH 3.

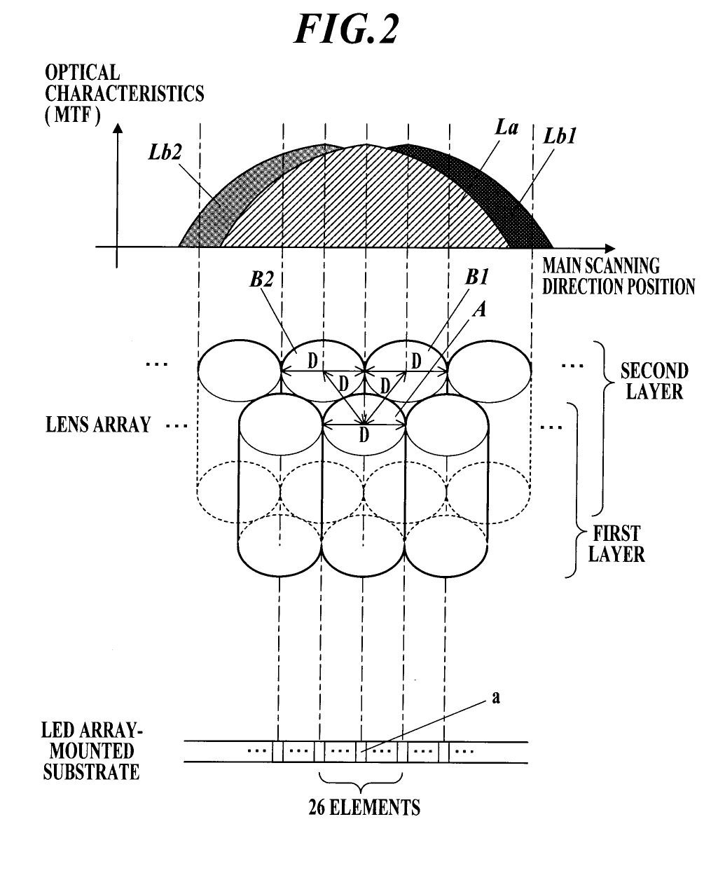

According to the present embodiment, the arrangement of the imaging lenses is an arrangement referred to as a “trefoil formation” in which a plurality of imaging lenses are arrayed in two rows in the main scanning direction. FIG. 2 illustrates a relation between an arrangement example of imaging lenses in a “trefoil formation” and light emitting elements. As shown in FIG. 2, the “trefoil formation” is a formation in which a first layer is formed by aligning cylindrical imaging lenses so as to be adjacent in a radial direction, and each imaging lens of a second layer that are aligned in the same manner as in the first layer are disposed in valleys that occur between two imaging lenses that are adjacent to each other in the first layer. According to the “trefoil formation” arrangement, a distance from one axis to another axis of two adjacent imaging lenses is the length of the sum of the radii of the two imaging lenses in question, that is, the length of a diameter D.

It is known that, in the case of a “trefoil formation” arrangement, when an imaging lens A at which an optical contribution of light irradiated from a given light emitting element a is highest is inclined, an influence is also imparted to imaging lenses B1 and B2 at which the optical contributions are next highest after the imaging lens in question (that is, two imaging lenses B1 and B2 of a different layer to the layer to which the imaging lens A belongs and which are adjacent to the imaging lens A). Thus a black stripe arises that is the result of the involvement of a plurality of lens elements.

If the LPH resolution is 1200 [dpi], the number of light emitting elements arrayed on the diameter D of an imaging lens is approximately 26 elements. The optical characteristics when the light emitting element a shown in FIG. 2 is turned on result from optical characteristics La produced by the imaging lens A and optical characteristics Lb1 and Lb2 produced by the imaging lenses B1 and B2. The number of light emitting elements at which irradiated light is received and condensed with respect to the imaging lenses A, B1, and B2 is the number of light emitting elements arrayed on the diameters D of two adjacent imaging lenses (approximately 52 elements). Accordingly, since approximately 52 elements is the minimum number of elements that contribute to the detection accuracy with respect to the occurrence of a black stripe, it is preferable to take this number of elements as the first moving average segment.

For the second moving average segment, it is required that the segment includes a number of elements necessary for smoothing an MTF curve obtained by graphing an MTF value of each light emitting element. For example, when the first moving average segment is taken to be 52 elements, preferably the second moving average segment is 768 elements.

The third calculation processing is processing that calculates as a third operation value a difference value (moving average difference) obtained as a difference between a second moving average value and a first moving average value based on the first moving average value as a first operation value and the second moving average value as a second operation value for each light emitting element.

After the third calculation processing, black stripe correction data is generated based on the third operation values calculated by the third calculation processing and a previously set threshold value. Preferably the threshold value is no less than 1.6 and no more 2.0.

The black stripe correction data includes a correction peak value MP, a peak element number PP, and segment information of a correction target segment.

The term “correction target segment” refers to a segment of light emitting elements in which the third operation value is a value of 1 or more with respect to a segment of light emitting elements in which the third operation value is equal to or greater than the previously set threshold value.

The correction peak value MP is the maximum value of the third operation value in the correction target segment, that is, the maximum value of values calculated based on the optical characteristics data.

The peak element number PP is the element number (maximum element number) of a light emitting element that corresponds to the correction peak value MP.

Segment information is the number of elements from the peak element number PP to one end and another end of the correction target segment. In the segment information, light amount manipulation variables that are respective correction values that correct light amount correction values in accordance with the correction peak value MP are specified, and the segment information includes the number of elements to one end and to the other end of the segment in accordance with each relevant light amount manipulation variable.

For example, the number of elements of a segment in which the light amount manipulation variable is a correction peak value is the sum of a peak correction start number MP1A and a peak correction end number MP1B. The peak correction start number MP1A is the number of elements from the peak element number PP to a light emitting element at one end of the segment in question. The peak correction end number MP1B is the number of elements from the peak element number PP to a light emitting element at the other end of the segment in question. Accordingly, a segment in which the light amount manipulation variable is the correction peak value is a segment from a element number obtained by subtracting the peak correction start number MP1A from the peak element number PP to a element number obtained by adding the peak correction end number MP1B to the peak element number PP.

The memory 17b includes a non-volatile memory such as a flash memory, and rewritably stores various programs and data. The memory 17b also stores an LPH inspection processing program, a light amount correction table that stores initial light amount correction values that are previously set with respect to each light emitting element provided in the LPH 3, a line period used in the first to third light amount adjustment processing, an exposure time, various turn-on patterns used in MTF measurement processing, and various required data such as a threshold value. In addition, the memory 17b stores a table of light amount measurement values (light amount measurement table) obtained by receiving light with the light receiving section 13, and various operation values and the like.

The memory 17b also stores basic correction data and black stripe correction data generated in the LPH inspection processing.

The display section 17c includes a display screen that uses a LCD (Liquid Crystal Display) or an organic EL (Electronic Luminescent) element or the like. The display section 17c displays various display screens for inputting various setting conditions or various display screens that display various processing results and the like in accordance with a display signal input from the control section 17a.

The operation section 17d includes various operation key groups and a touch panel that covers the display screen of the display section 17c. The operation section 17d outputs an operation signal that has been input from an operation key group or the touch panel to the control section 17a.

The external I/F 17e includes various interfaces such as a network interface card (NIC), a MODEM (MOdulator-DEModulator), and a USB (Universal Serial Bus). The external I/F 17e sends and receives data to and from an external device or image forming apparatus or the like that is communicably connected to the external I/F 17e.

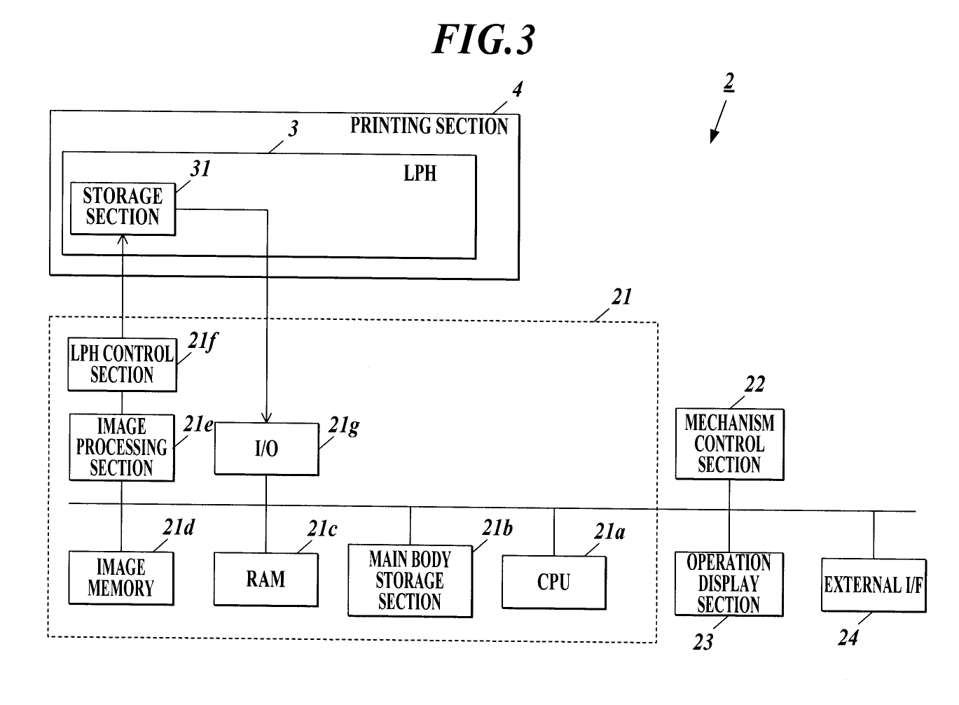

FIG. 3 illustrates a control block diagram of an image forming apparatus 2 according to the present embodiment.

The image forming apparatus 2 is a digital multi-function machine equipped with, for example, a copy function that reads an image from an original copy and forms an image of the read image on a sheet such as paper; and a printer function that receives image data from an external device such as a PC (Personal Computer), forms an image represented by the image data on a sheet, and outputs the sheet with the image formed thereon, and the like.

As shown in FIG. 3, the image forming apparatus 2 includes a main body control section 21, a mechanism control section 22, an operation display section 23, an external I/F 24, the LPH 3, a printing section 4, an image reading section (unshown), and the like. The sections are connected by a bus.

The main body control section 21 includes a CPU 21a, a main body storage section 21b, a RAM 21c, an image memory 21d, an image processing section 21e, a LPH control section 21f that is connected to the image processing section 21e, an I/O (input/output) 21g, and the like.

The CPU 21a reads out a system program, respective processing programs, and data that are stored in the main body storage section 21b, expands the relevant program or data inside the main body storage section 21b or the RAM 21c, and performs centralized control of operations of each section of the image forming apparatus 2 according to the expanded program. The CPU 21a performs timing control of the overall system, control for storing and accumulating image data for which the main body storage section 21b or the RAM 21c is used, input/output control of image data with respect to the print section, and control of interfaces (I/F) with other applications (FAX, printer, scanner, etc.) and operations thereof.

The CPU 21a also reads out other various data and the like such as an LPH adjustment processing program that is stored in the main body storage section 21b and executes LPH adjustment processing.

In the LPH adjustment processing, basic correction data (first correction data) and black stripe correction data (second correction data) is read out from the storage section 31 of the LPH 3, an adjustment menu screen is displayed on the operation display section, the basic correction data is corrected based on the black stripe correction data that has been adjusted according to adjustment instruction information input from the operation display section, and the corrected basic correction data is stored in the main body storage section 21b. The LPH adjustment processing also includes processing in which an image based on image data for image quality confirmation that uses the corrected basic correction data is formed on a sheet by the printing section 4 and output.

The adjustment menu screen displays black stripe correction data that has been read out, and also accepts adjustment instruction information with respect to the black stripe correction data.

The main body storage section 21b includes a non-volatile memory such as a flash memory. Various programs corresponding to the image forming apparatus 2 and data necessary for processing with the various programs are previously stored in the main body storage section 21b. The main body storage section 21b also stores an LPH adjustment processing program and various data required for the LPH adjustment processing program such as image data for image quality confirmation.

The main body storage section 21b also includes a light amount correction data memory.

The light amount correction data memory is configured using a rewritable non-volatile memory such as an EEPROM (Electronically Erasable and Programmable Read Only Memory). The light amount correction data memory stores data (basic correction data, black stripe correction data, and the like) that is read out from the LPH 3, and basic correction data that has been corrected with the LPH adjustment processing program.

The RAM 21c is a temporary storage region for a program read out from the main body storage section 21b, input or output data, and parameters and the like used in various processing executed by the CPU 21a.

The image memory 21d includes an image data memory.

The image data memory is configured using a DRAM (Dynamic RAM) or the like. The image data memory stores image data that has been sent from the image reading section or the external I/F 24 or the like.

The image processing section 21e performs image processing (scaling, filtering, gamma conversion, and the like) of image data stored in the image memory 21d, and generates print data as a print output object.

The LPH control section 21f stores print data generated by the image processing section 21e, and outputs various signals based on the generated print data or data written into the storage section 31 of the LPH 3 to the LPH 3.

The I/O 21g outputs basic correction data and black stripe correction data read out from the storage section 31 of the LPH 3 to the CPU 21a, and stores the aforementioned data in the light amount correction data memory of the main body storage section 21b.

The mechanism control section 22 performs overall control of various driving mechanisms and various sensors and the like inside the image forming apparatus 2 based on signals from the main body control section 21. For example, the mechanism control section 22 drivingly controls a motor that rotates a photosensitive drum constituting an image forming section at a constant speed.

The operation display section 23 includes a display screen that uses an LCD (Liquid Crystal Display) or an organic EL (Electronic Luminescent) element or the like, and an operation key group including ten-keys and a power switch, and the like. A touch panel is provided on the display screen so as to cover the display screen. Various setting screens for inputting various setting conditions, an adjustment menu screen, an operation state of the image forming apparatus 2, processing results and the like are displayed on the display screen in accordance with a display signal that is input from the main body control section 21. Further, the operation display section 23 sends an operation signal that is input from the operation key group or the touch panel to the main body control section 21.

The external I/F 24 includes various interfaces such as a network interface card (NIC), a MODEM (MOdulator-DEModulator), and a USB (Universal Serial Bus). The external I/F 24 sends and receives information to and from an external device or the control apparatus 17 constituting the LPH inspection system that is communicably connected to the external I/F 24.

The printing section 4 includes an image forming section including the LPH 3, a cleaning section, a transfer belt, a paper feeding section, a conveying section, a fixing section and the like, and forms an image on a paper sheet or the like.

Next, the operations of the present embodiment will be described.

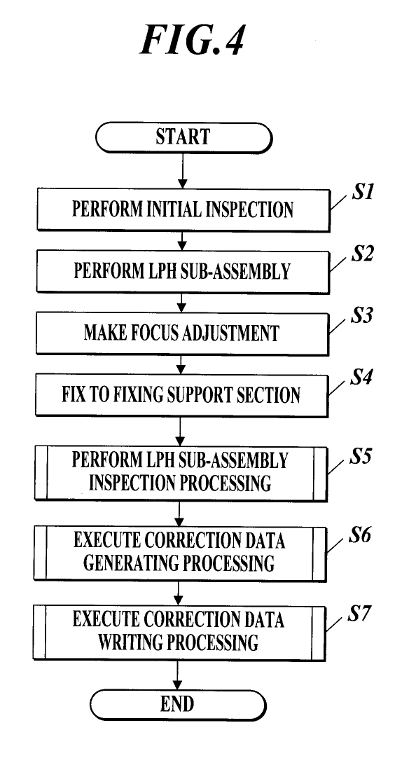

FIG. 4 shows a flowchart of LPH inspection processing according to the present embodiment.

The LPH inspection processing shown in FIG. 4 is executed by the LPH inspection system 1.

First, an initial inspection of the LPH 3 is performed (step S1). In the initial inspection, the outer appearance of each component comprising the LPH 3 is observed, it is confirmed whether or not there are any flaws or dirt, and processing is performed in which initial values such as a light amount of the LPH 3, an MTF value, and a focus position are set.

After the initial inspection, LPH sub-assembly is performed to assemble each component comprising the LPH 3 as well as attachment members (step S2). The LPH 3 for which sub-assembly has been performed is provisionally installed in the LPH fixing member 12, and positioning with respect to the light receiving section 13 and adjustment of the focus position is performed (step S3).

After adjusting the focus position, adhesion and drying of various components comprising the LPH 3 is performed, and the LPH 3 is fixed to a fixing support section such as the LPH fixing member 12 (step S4).

LPH sub-assembly inspection processing is executed with respect to the LPH 3 that is fixed to the LPH fixing member 12 (step S5). After step S5, correction data generating processing is executed (step S6). After step S6, correction data writing processing is executed (step S7), and thereafter processing at the LPH inspection system 1 is ended.

The correction data writing processing in step S7 may also be executed by the LPH inspection system 1 and the image forming apparatus 2 performing communication after the LPH 3 has been mounted to a predetermined position of the image forming apparatus 2. This will be described in detail later.

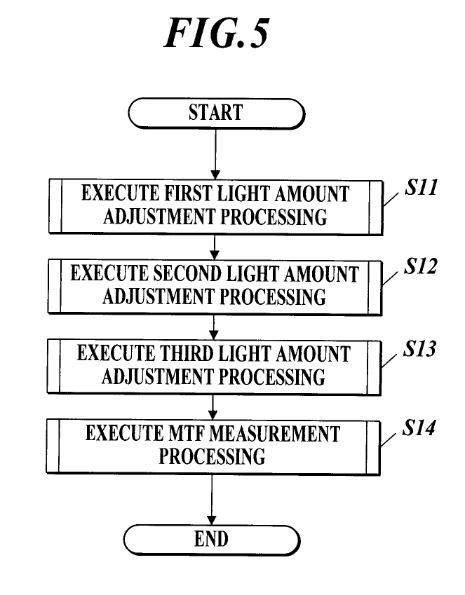

FIG. 5 illustrates a flowchart of the LPH sub-assembly inspection processing executed by the LPH inspection system 1. The processing illustrated in FIG. 5 is executed in cooperation between the control section 17a and the respective sections.

The control section 17a executes first light amount adjustment processing (step S11). After executing the first light amount adjustment processing, the control section 17a executes second light amount adjustment processing (step S12). After executing the second light amount adjustment processing, the control section 17a executes third light amount adjustment processing (step S13).

When execution of the third light amount adjustment processing by the control section 17a is completed, adjustment is performed so that light amount variations of the light emitting elements provided in the LPH 3 are equal to or less than a preset value. Further, basic correction data is generated in which light amount correction values for each light emitting element are associated with an element number.

The first to third light amount adjustment processing will be described in detail later.

The control section 17a executes MTF measurement processing with respect to the LPH 3 for which the light amount variations of the light emitting elements have been adjusted (step S14), and ends the LPH sub-assembly inspection processing. Normal processing that calculates an MTF value of each light emitting element for each turn-on pattern and simplified processing that calculates a common MTF value of a plurality of elements that are consecutively arrayed are available for the MTF measurement processing. Use of simplified processing is preferable from the viewpoint of improving the computational efficiency, and simplified processing is used according to the present embodiment.

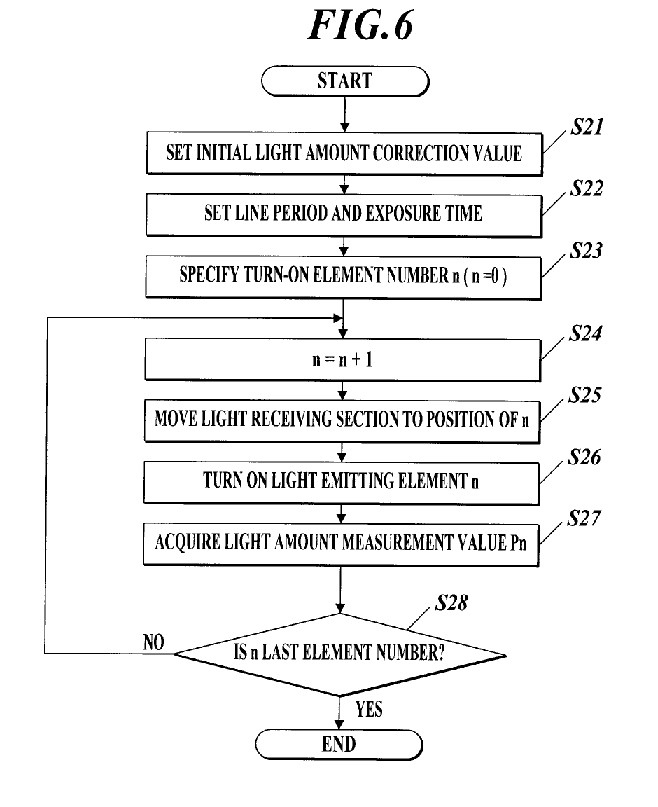

FIG. 6 illustrates a flowchart of the first light amount adjustment processing.

The control section 17a reads out a light amount correction table that stores initial light amount correction values that are set by the initial inspection from the memory 17b. The initial light amount correction values as electric current adjustment values of the respective light emitting elements are set in each light emitting element by the LPH control section 15 (step S21). The control section 17a also reads out a line period and an exposure time from the memory 17b, and a line period of the LPH 3 and an exposure time of each light emitting element is set in the LPH 3 by the LPH control section 15 (step S22).

The control section 17a specifies an element number n of a light emitting element to be turned on (turn-on element number) as “0” (step S23), and thereafter adds 1 to the turn-on element number n (step S24). Next, the control section 17a causes the light receiving control section/driving control section 16 to drive the driving section 14 to move the light receiving section 13 to a position corresponding to the turn-on element number n (step S25).

The control section 17a causes the LPH control section 15 to turn on a light emitting element of turn-on element number n (step S26). Next, the control section 17a acquires a light amount measurement value P(n) obtained by using the light receiving control section/driving control section 16 to convert a light amount value that is a value of light received by the light receiving section 13, and stores the light amount measurement value P(n) in the light amount measurement table (step S27).

The control section 17a determines whether or not the turn-on element number n is the last element number (step S28). If the turn-on element number n is not the last element number (No in step S28), the control section 17a returns to the processing of step S24. If the turn-on element number n is the last element number (Yes in step S28), the control section 17a ends the first light amount adjustment processing.

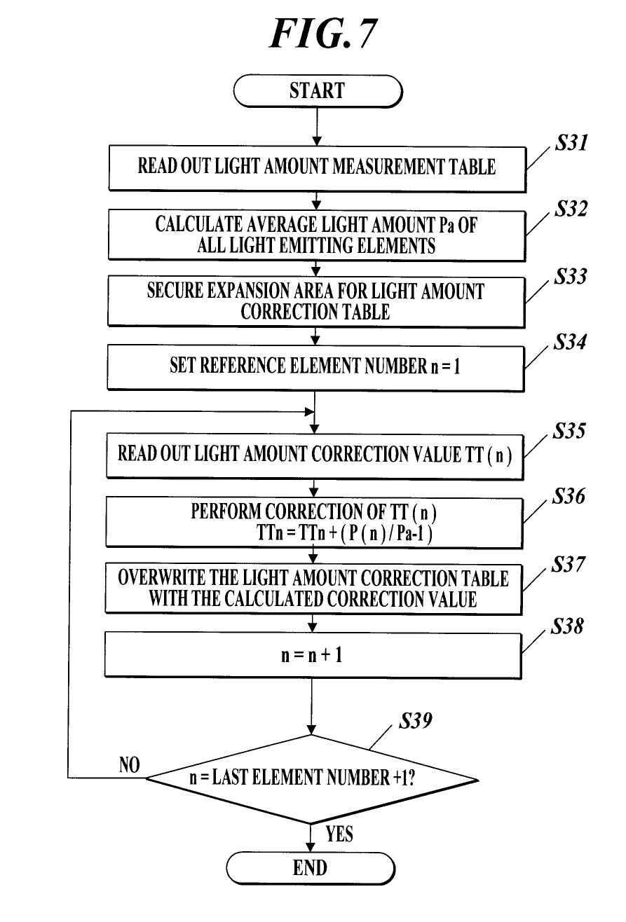

FIG. 7 illustrates a flowchart of second light amount adjustment processing.

The control section 17a reads out the light amount measurement table stored in the memory 17b (step S31), calculates an average light amount Pa of all light emitting elements based on the light amount measurement value of each light emitting element (step S32), and secures an area for expanding the light amount correction table in the memory 17b (step S33).

The control section 17a sets a element number (reference element number) n of a light emitting element to be referred to as “1” (step S34), and reads out a light amount correction value TT(n) of the reference element number n that is stored in the light amount correction table (step S35).

The control section 17a performs correction of the light amount correction value TT(n) of the reference element number n that is read out based on the relevant light amount correction value TT(n), the light amount measurement value P(n) of the relevant reference element number n, and the average light amount Pa, and calculates a new light amount correction value TT(n) (step S36). More specifically, the light amount correction value TT(n) that is read out is added to a value obtained by subtracting 1 from a value obtained by dividing the light amount measurement value P(n) by the average light amount Pa, and the resulting value is taken to be a new light amount correction value TT(n). A calculation formula for the new light amount correction value TT(n) is shown in formula (1) below.

TT(n)=TT(n)+(P(n)/Pa−1) (1)

The control section 17a overwrites the light amount correction table with the light amount correction value TT(n) calculated in step S36 (step S37). Next, the control section 17a adds 1 to the reference element number n (step S38).

The control section 17a determines whether or not the reference element number n is a value obtained by adding 1 to the last element number (step S39). If the reference element number n is not a value obtained by adding 1 to the last element number (No in step S39), the control section 17a returns to the processing in step S35. If the reference element number n is a value obtained by adding 1 to the last element number (Yes in step S39), the control section 17a ends the second light amount adjustment processing.

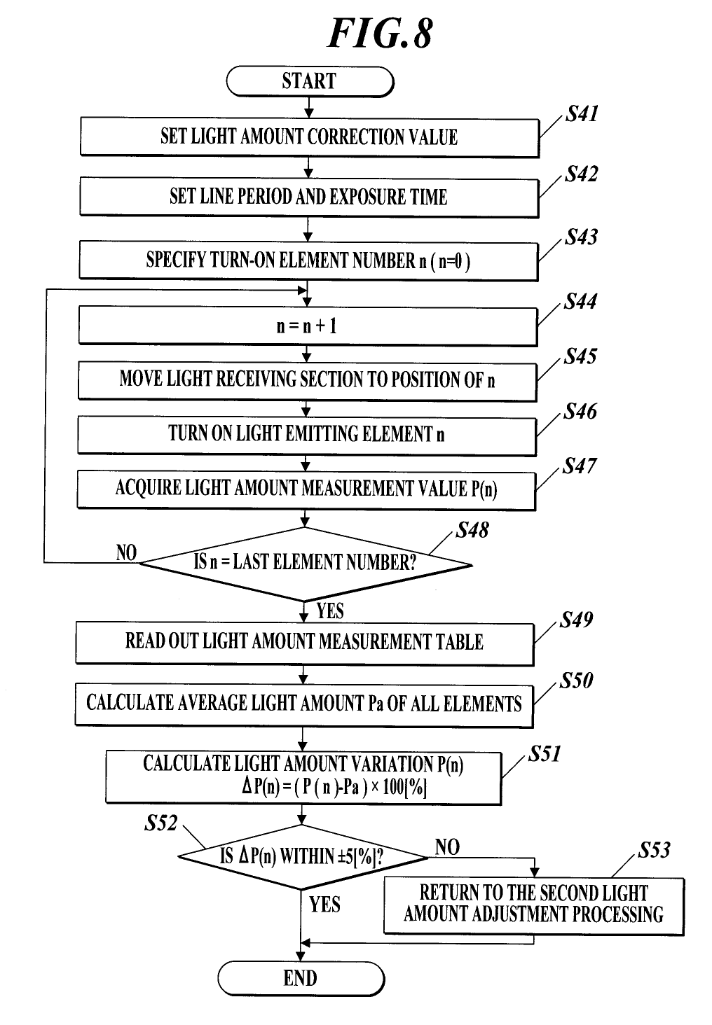

FIG. 8 illustrates a flowchart of the third light amount adjustment processing.

The control section 17a reads out the light amount correction table stored in the memory 17b (that is, the light amount correction table in which light amount correction values calculated by the second light amount adjustment processing are stored), and light amount correction values that serve as electric current adjustment values of the respective light emitting elements are set in each light emitting element by the LPH control section 15 (step S41). Steps S42 to S48 are the same as steps S22 to S28 of the first light amount adjustment processing, and hence a description thereof is omitted here.

The control section 17a reads out the light amount measurement table that is generated by the present processing (step S49), and calculates an average light amount Pa of all light emitting elements based on the light amount measurement value of each light emitting element (step S50).

The control section 17a calculates a light amount variation ΔP(n) of each light emitting element based on a light amount measurement value P(n) of each light emitting element and the average light amount Pa (step S51). More specifically, a value shown as a percentage [%] that is obtained by multiplying by 100 a value obtained by subtracting the average light amount Pa from the light amount measurement value P(n) is calculated as the light amount variation ΔP(n). A calculation formula for the light amount variation ΔP(n) of the light emitting element of element number n is shown in formula (2) below.

ΔP(n)=(P(n)−Pa)×100[%] (2)

The control section 17a determines whether or not the light amount variations ΔP(n) of all the light emitting elements are within ±5[%] (step S52). If the light amount variations ΔP(n) of all the light emitting elements are not within ±5[%] (No in step S52), the control section 17a returns to the second light amount adjustment processing (step S53) and ends the third light amount adjustment processing. If the light amount variations ΔP(n) of all the light emitting elements are within ±5[%] (Yes in step S52), the control section 17a ends the third light amount adjustment processing.

By executing the first to third light amount adjustment processing, a light amount correction table is generated in which light amount variations of all light emitting elements are within a predetermined range (±5[%]). This light amount correction table serves as the basic correction data. Further, by executing the first to third light amount adjustment processing it is possible to improve the calculation accuracy of an MTF value of each light emitting element that is calculated by MTF measurement processing executed later, and to improve the reliability of the accuracy with respect to the characteristics of a correction target light emitting element.

Next, MTF measurement processing will be described.

Turn-on patterns for the MTF measurement processing include three turn-on patterns that include a 1 (on)—1 (off), a 1 (on)—3 (off), and a 2 (on)—2 (off) pattern. The types of MTF measurement processing are combinations of one of the turn-on patterns and MTF calculation processing that is either normal processing or simplified processing. The MTF measurement processing according to the present embodiment is simplified processing with the 1 (on)—3 (off) turn-on pattern.

Hereunder, MTF measurement processing using the simplified processing with the 1 (on)—3 (off) turn-on pattern will be described.

The MTF measurement processing that uses simplified processing with the 1 (on)—3 (off) turn-on pattern takes four consecutively arranged light emitting elements as one set, calculates the MTF value of any one light emitting element of each set, and takes the MTF value in question as a common MTF value of the set.

According to the MTF measurement processing using simplified processing with the 1 (on)—3 (off) turn-on pattern of the present embodiment, every fourth light emitting element from the first light emitting element (for example, light emitting elements with element number n=1, 5, 9 . . . ) are turned on in sequence, and maximum light amount values with respect to the light emitting elements that are turned on are acquired. Further, the light receiving section 13 is moved to positions of light emitting elements at center positions of three consecutive light emitting elements that are between the turned on elements (for example, positions of light emitting elements with element number n=3, 7, 11 . . . ), to thereby acquire minimum light amount values with respect to the light emitting elements that are turned on. Subsequently, according to the MTF measurement processing using simplified processing with the 1 (on)—3 (off) turn-on pattern, an MTF value is calculated based on the maximum light amount value and the minimum light amount value, and the MTF value in question serves as the common MTF value of the respective set.

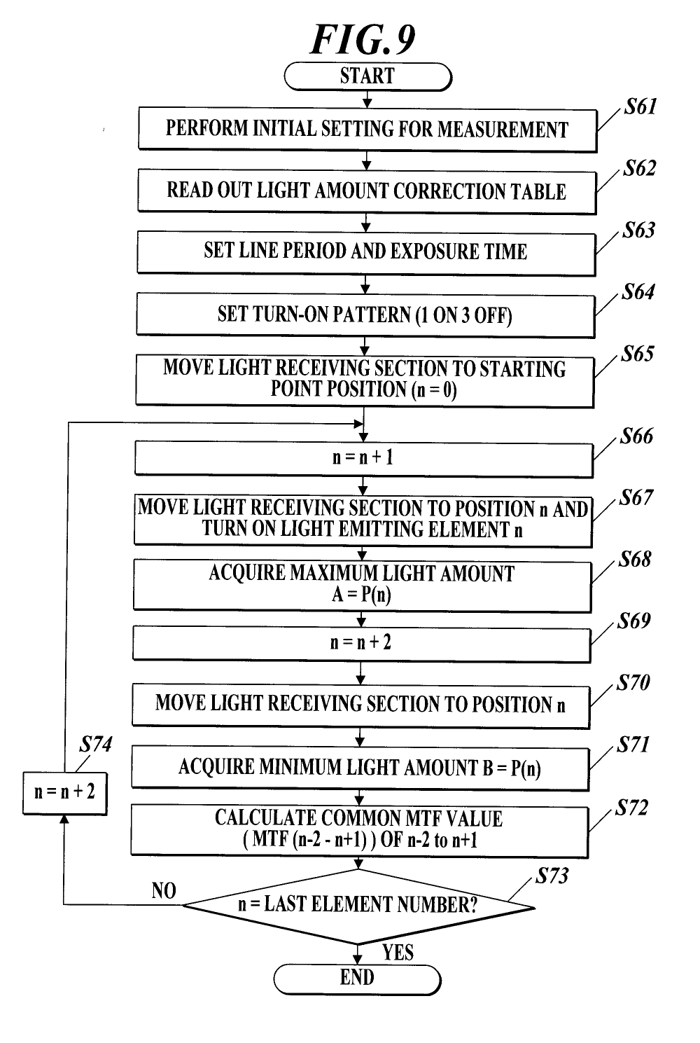

FIG. 9 illustrates a flowchart of MTF measurement processing using simplified processing with the 1 (on)—3 (off) turn-on pattern.

The control section 17a performs initial setting of each section prior to measurement (step S61). For example, the light receiving section 13 is moved to a starting point position on the guide rail by the light receiving control section/driving control section 16, and reference adjustment of the light receiving section 13 and initial setting of an A/D conversion circuit inside the light receiving control section/driving control section 16 or a storage memory and the like are performed.

After step S61, the control section 17a reads out the light amount correction table (basic correction data) from the memory 17b, and uses the LPH control section 15 to set a basic correction value as an electric current adjustment value of each light emitting element in the respective light emitting elements (step S62). Light amount correction values calculated by the second light amount adjustment processing are stored in the light amount correction table read out in step S62.

The control section 17a also reads out a line period and an exposure time from the memory 17b, and a line period of the LPH 3 and an exposure time of each light emitting element is set in the LPH 3 by the LPH control section 15 (step S63).

The control section 17a sets the turn-on pattern to a 1 (on)—3 (off) pattern that sequentially lights a light emitting element disposed at one end of each set by means of the LPH control section 15 (step S64). The control section 17a moves the light receiving section 13 to the starting point position by means of the light receiving control section/driving control section 16, and also sets the reference element number n to 0 (step S65).

The control section 17a adds 1 to the reference element number n (step S66). Next, the control section 17a causes the light receiving control section/driving control section 16 to drive the driving section 14 to move the light receiving section 13 to a position corresponding to the reference element number n, and causes the LPH control section 15 to turn on a light emitting element with the reference element number n (step S67). The control section 17a acquires a light amount measurement value P(n) obtained upon conversion by the light receiving control section/driving control section 16 of a light amount value of light received by the light receiving section 13, as a maximum light amount value A of the light emitting element that has been turned on (step S68).

The control section 17a adds 2 to the reference element number n (step S69). Next, the control section 17a drives the driving section 14 by means of the light receiving control section/driving control section 16 to move the light receiving section 13 to a position corresponding to the reference element number n (step S70). The control section 17a acquires a light amount measurement value P(n) obtained upon conversion by the light receiving control section/driving control section 16 of a light amount value of light received by the light receiving section 13, as a minimum light amount value B of the light emitting element that is turned on in step S67 (step S71).

Based on the maximum light amount value A acquired in step S68 and the minimum light amount value B acquired in step S71, the control section 17a calculates a common MTF value MTF(n−2 to n+1) for the reference element numbers n−2 to n+1 and the reference element number n (step S72), and stores the calculated MTF value in the memory 17b. Calculation of the MTF value in step S72 is carried out according to the following formula (3).

MTF(n−2 to n+1)={(A−B)/(A+B)}×100[%] (3)

The control section 17a determines whether or not the reference element number n is the last element number (step S73). If the reference element number n is not the last element number (No in step S73), the control section 17a adds 2 to the reference element number n (step S74), and returns to the processing of step S66. If the reference element number n is the last element number (Yes in step S73), the control section 17a ends the MTF measurement processing using simplified processing with the 1 (on)—3 (off) turn-on pattern.

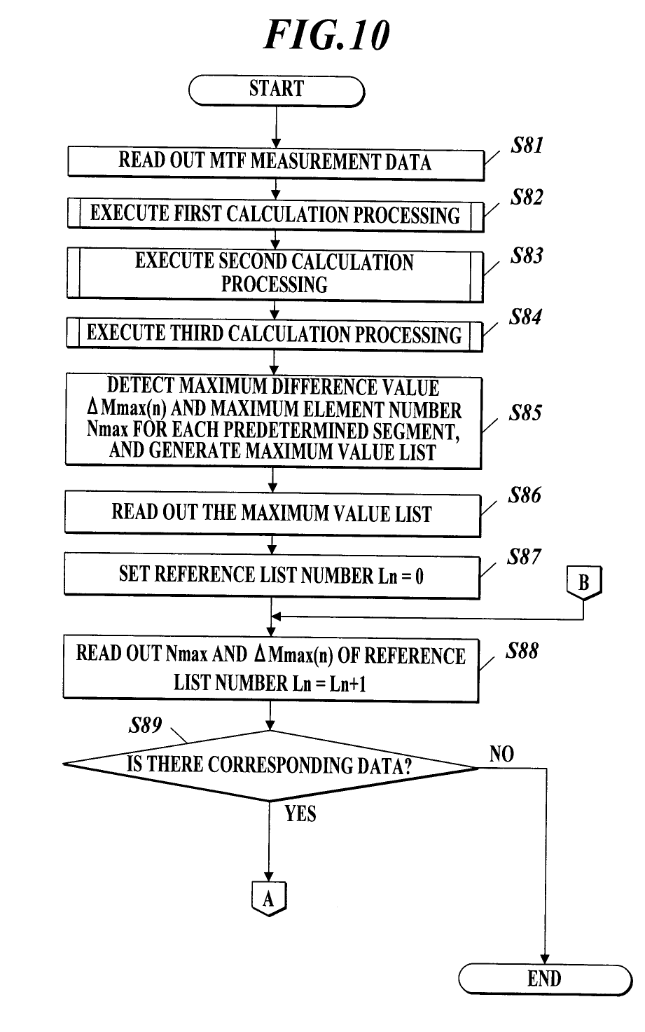

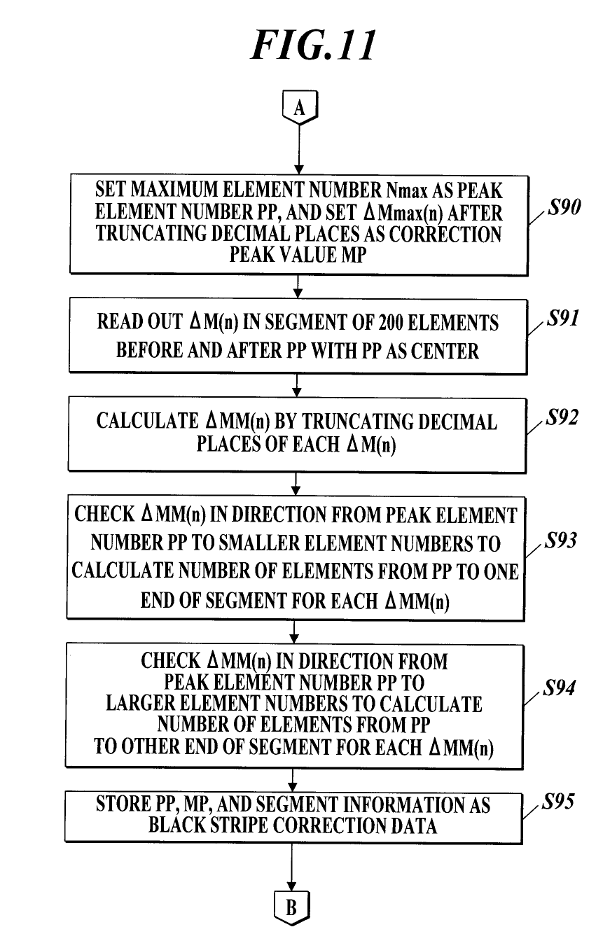

FIG. 10 and FIG. 11 illustrate flowcharts of the correction data generating processing executed by the LPH inspection system 1. The processing illustrated in FIG. 10 and FIG. 11 is executed in cooperation between the control section 17a and the respective sections.

The control section 17a reads out an MTF value of each light emitting element obtained with MTF measurement processing from the memory 17b (step S81), and executes first calculation processing (step S82). The first calculation processing according to the present embodiment takes a first moving average segment to be 52 elements, and calculates a first moving average value of each light emitting element by taking each light emitting element as the center of the first moving average segment in question.

Hereunder, first calculation processing in a case in which MTF values have been calculated by simplified processing will be described.

MTF values calculated by simplified processing according to the present embodiment are MTF values that are common for every four light emitting elements. Accordingly, assuming that the first moving average segment is 52 elements, a first moving average value is calculated using 13 set units with each set comprising four elements. For example, a first moving average value of each set is calculated based on the MTF values of light emitting elements with element numbers that are a multiple of 4. A first moving average value MTFa1(n) of a light emitting element with the smallest element number among light emitting elements included in a set number m is calculated by the following formula (4).

$$MTFa 1 ( n ) = \frac{\{ \begin{matrix}\begin{matrix}MTF ( n - 24 ) + MTF ( n - 20 ) + \\ MTF ( n - 16 ) + MTF ( n - 12 ) + \\ MTF ( n - 8 ) + MTF ( n - 4 ) + MTF ( n ) +\end{matrix} \\ MTF ( n + 4 ) + MTF ( n + 8 ) + MTF ( n + 12 ) + \\ MTF ( n + 16 ) + MTF ( n + 20 ) + MTF ( n + 24 )\end{matrix} \}}{13} \qquad ( 4 )$$

The first moving average value of light emitting elements of sets (first set to sixth set) of less than half the number of the first moving average segment is taken as the first moving average value of the light emitting elements of the seventh set. Further, the first moving average value of light emitting elements of sets (M set to M−6th set) of a segment of half the number of the first moving average segment from the final set (M set) is taken as the first moving average value of the light emitting elements of the M−7th set.

After step S81, the control section 17a executes second calculation processing (step S83). The second calculation processing according to the present embodiment takes a second moving average segment as 768 elements, and calculates a second moving average value of each light emitting element by taking the light emitting element as the center of the second moving average segment in question.

Hereunder, second calculation processing in a case in which MTF values have been calculated by simplified processing will be described.

As described above, MTF values calculated by simplified processing are MTF values that are common for every four light emitting elements. Accordingly, assuming that the second moving average segment is 768 elements, a second moving average value is calculated using 192 set units with each set comprising four elements. For example, a second moving average value of each set is calculated based on MTF values of light emitting elements with element numbers that are a multiple of 4. A second moving average value MTFa2(n) of a light emitting element with the smallest element number among light emitting elements included in a set number m is calculated by the following formula (5).

$$MTFa 2 ( n ) = \frac{\{ \begin{matrix}\begin{matrix}MTF ( n - 384 ) + MTF ( n - 380 ) + … + \\ MTF ( n - 4 ) + MTF ( n ) + \\ MTF ( n + 4 ) + … +\end{matrix} \\ MTF ( n + 376 ) + MTF ( n + 380 )\end{matrix} \}}{192} \qquad ( 5 )$$

The second moving average value of light emitting elements of sets (first set to ninety-sixth set) of less than half the number of the second moving average segment is taken as the second moving average value of the light emitting elements of the ninety-seventh set (light emitting elements with element numbers n=385 to 388). Further, the second moving average value of the light emitting elements of sets (M set to M−96th set) of a segment of half the number of the second moving average segment from the final set (M set) is taken as the second moving average value of the light emitting elements of the M−97th set.

After the first calculation processing and the second calculation processing, the control section 17a executes third calculation processing that calculates a difference value ΔM(n) obtained as a difference between the second moving average value MTFa2(n) and the first moving average value MTFa1(n) of each light emitting element (step S84).

The control section 17a detects a maximum difference value ΔMmax(n) for each predetermined segment, and element numbers (maximum element numbers Nmax) of light emitting elements with the relevant maximum difference values ΔMmax(n). Subsequently, the control section 17a assigns list numbers in the order of the element numbers of the maximum element numbers Nmax, generates a maximum value list in which the detected maximum element numbers Nmax and maximum difference values ΔMmax(n) are stored (step S85), and stores the maximum value list in the memory 17b.

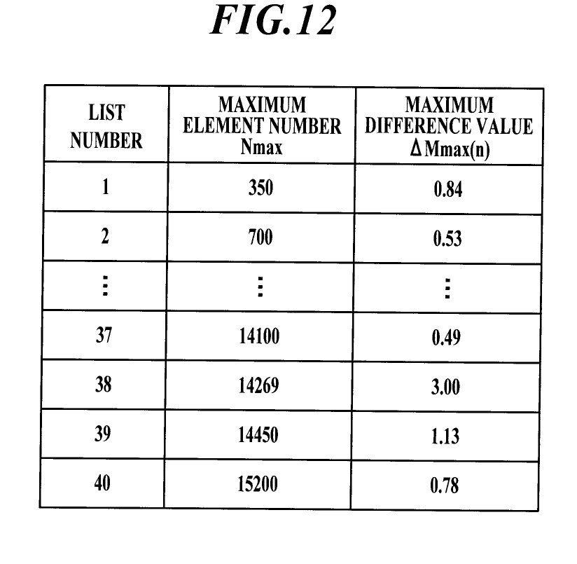

FIG. 12 shows an example of the maximum value list.

The maximum value list shown in FIG. 12 illustrates an example in a case where the predetermined segments in step S85 are taken to be, for example, 40 segments of 384 element units in a case in which 15,360 pixels are arrayed in the main scanning direction for the light emitting elements. In this case, among light emitting elements for which the difference value ΔM(n) is equal to or greater than a previously set threshold value for each unit of 384 elements, a element number (maximum element number Nmax) of a light emitting element at which the difference value ΔM(n) is maximum and a difference value ΔM(n) of the maximum element number Nmax(n) (that is, a maximum difference value ΔMmax(n)) are detected. Accordingly, a maximum value list is created in which list numbers are assigned to maximum element numbers Nmax and maximum difference values ΔMmax(n) with respect to 40 segments, respectively.

The control section 17a reads out the maximum value list from the memory 17b (step S86), and sets a list number to be referenced (reference list number) Ln to 0 (step S87).

The control section 17a reads out a maximum element number Nmax and a maximum difference value ΔMmax(n) with respect to a reference list number Ln obtained by adding 1 to the reference list number Ln (step S88).

The control section 17a determines whether or not data corresponding to the maximum element number Nmax and the maximum difference value ΔMmax(n) for the reference list number Ln exists in the maximum value list. More specifically, the control section 17a determines whether or not the maximum element number Nmax and the maximum difference value ΔMmax(n) for the reference list number Ln could be read out in step S88 (step S89). If data corresponding to the maximum element number Nmax and the maximum difference value ΔMmax(n) for the reference list number Ln does not exist in the maximum value list (No in step S89), the control section 17a ends the correction data generating processing.

If data corresponding to the maximum element number Nmax and the maximum difference value ΔMmax(n) for the reference list number Ln does exist in the maximum value list (Yes in step S89), the control section 17a sets the maximum element number Nmax read out in step S88 as a peak element number PP, and sets the maximum difference value ΔMmax(n) after truncating the decimal places thereof as a correction peak value MP (step S90).

The control section 17a reads out from the memory 17b the element numbers and the difference values ΔM(n) in a segment of a predetermined number of elements with the peak element number PP as the center of the segment (step S91). The segment, for example, includes 200 elements before and after the peak element number PP with the peak element number PP as its center.

The control section 17a performs processing for dropping all digits to the right of the decimal point of each difference value ΔM(n) of the segment that is read out to thereby calculate each difference value after the processing (processed difference value ΔMM(n)) (step S92). The processed difference value ΔMM(n) serves as a light amount manipulation variable [%].

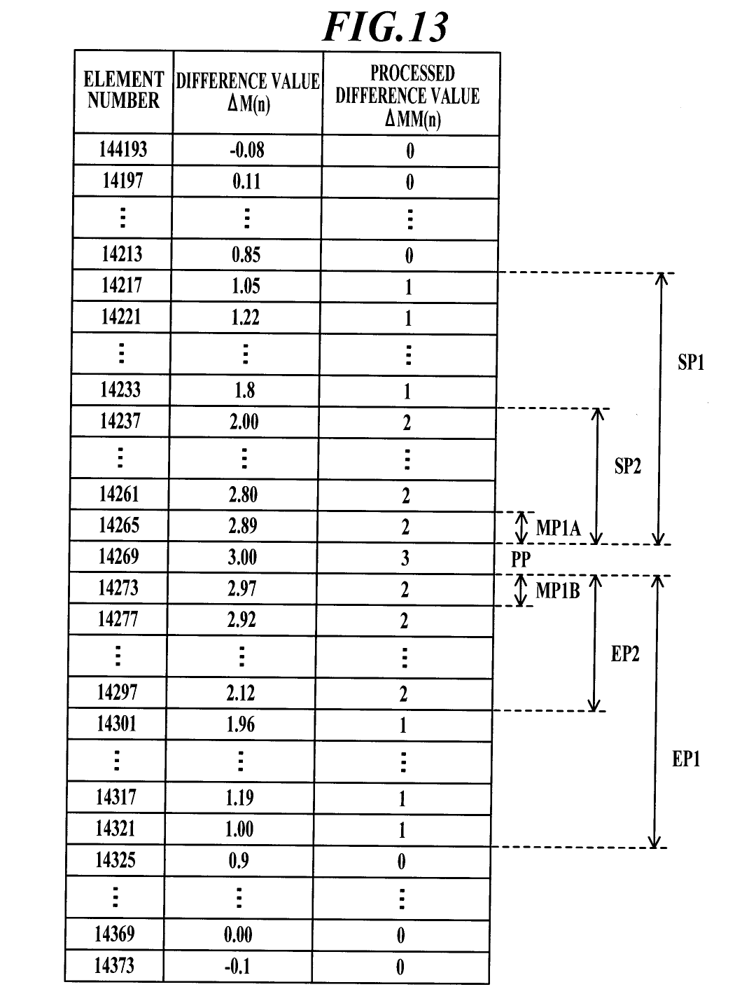

FIG. 13 shows an example of element numbers of light emitting elements, the difference values ΔM(n), and the processed difference values ΔMM(n), in a segment with the peak element number PP as its center.

The control section 17a checks each processed difference value ΔMM(n) in the direction from the peak element number PP towards element numbers of a smaller value, and calculates the number of elements as far as one end of the segment for each processed difference value ΔMM(n) (step S93).

In step S93, for example, when the correction peak value MP is 3, the number of elements as far as one end from the peak element number PP of each segment is calculated for cases in which the processed difference value ΔMM(n) is 3, 2, and 1, respectively.

More specifically, in the direction from the peak element number PP towards element numbers of a smaller value, a element number of a light emitting element at which the processed difference value ΔMM(n) becomes 2 from 3 (element number 14265 in FIG. 13) is detected, and a difference between the detected element number and the peak element number PP is calculated as the peak correction start number MP1A.

Further, in the direction from the peak element number PP towards element numbers of a smaller value, a element number of a light emitting element at which the processed difference value ΔMM(n) becomes 1 from 2 (element number 14237 in FIG. 13) is detected, and a difference between the detected element number and the peak element number PP is calculated as a second correction start number SP2.

Furthermore, in the direction from the peak element number PP towards element numbers of a smaller value, a element number of a light emitting element at which the processed difference value ΔMM(n) becomes 0 from 1 (element number 14217 in FIG. 13) is detected, and a difference between the detected element number and the peak element number PP is calculated as a first correction start number SP1.

The control section 17a checks each processed difference value ΔMM(n) in the direction from the peak element number PP towards element numbers of a higher value, and calculates the number of elements as far as the other end of the segment for each processed difference value ΔMM(n) (step S94).

In step S94, for example, when the correction peak value MP is 3, the number of elements as far as the other end from the peak element number PP of each segment is calculated for cases in which the processed difference value ΔMM(n) is 3, 2, and 1, respectively.

More specifically, in the direction from the peak element number PP towards element numbers of a higher value, a element number of a light emitting element at which the processed difference value ΔMM(n) becomes 2 from 3 (element number 14273 in FIG. 13) is detected, and a difference between the detected element number and the peak element number PP is calculated as the peak correction end number MP1B.

Further, in the direction from the peak element number PP towards element numbers of a higher value, a element number of a light emitting element at which the processed difference value ΔMM(n) becomes 2 from 1 (element number 14297 in FIG. 13) is detected, and a difference between the detected element number and the peak element number PP is calculated as a second correction end number EP2.

Furthermore, in the direction from the peak element number PP towards element numbers of a higher value, a element number of a light emitting element at which the processed difference value ΔMM(n) becomes 0 from 1 (element number 14321 in FIG. 13) is detected, and a difference between the detected element number and the peak element number PP is calculated as a first correction end number EP1.

The control section 17a stores the peak element number PP, the correction peak value MP, and segment information for each processed difference value ΔMM(n) as black stripe correction data in the memory 17b (step S95), and returns to the processing of step S88.

The segment information in step S95 is, for example, the peak correction start number MP1A and peak correction end number MP1B that indicate a segment in which the processed difference value ΔMM(n) as a light amount adjustment amount is the correction peak value MP; the second correction start number SP2 and the second correction end number EP2 that indicate a segment in which the processed difference value ΔMM(n) as a light amount adjustment amount is 2; and the first correction start number SP1 and first correction end number EP1 that indicate a segment in which the processed difference value ΔMM(n) as a light amount adjustment amount is 1.

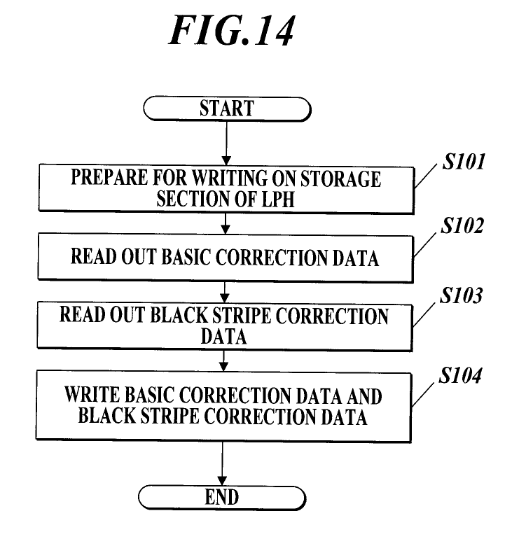

FIG. 14 illustrates a flowchart of correction data writing processing that is executed by the LPH inspection system 1. The processing shown in FIG. 14 is executed in cooperation between the control section 17a and the respective sections.

The control section 17a performs preparations for writing data to the storage section 31 inside the LPH 3 (step S101). In step S101, the control section 17a establishes a communication connection with the storage section 31 of the LPH 3 via the LPH control section 15.

The control section 17a reads out basic correction data from the memory 17b (step S102), reads out black stripe correction data from the memory 17b (step S103), writes the basic correction data and the black stripe correction data in the storage section 31 of the LPH 3 (step S104), and ends the correction data writing processing.

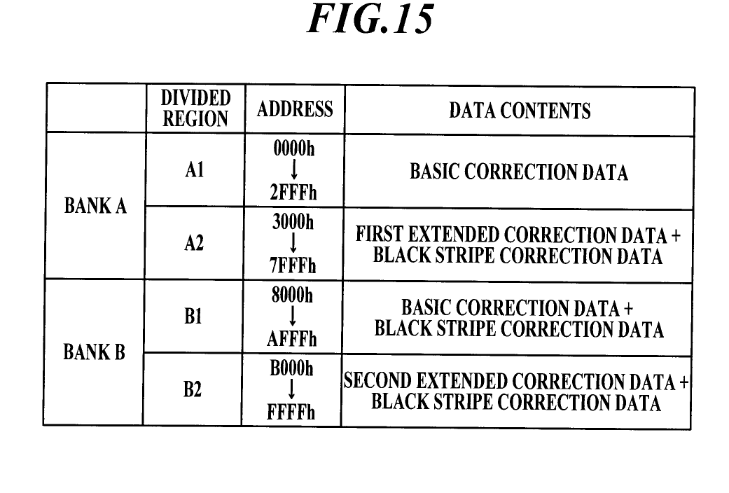

FIG. 15 illustrates an example of a memory configuration of the storage section 31 of the LPH 3.

As shown in FIG. 15, the memory region of the storage section 31 is divided into two regions (A bank and B bank). Each bank is further divided into two regions.

The A bank includes a divided region A1 with memory addresses “0000h” to “2FFFh”, and a divided region A2 with memory addresses “30000h” to “7FFFh”. Basic correction data is stored in the divided region A1. First extended correction data in which a light amount correction value for each light emitting element is different to the basic correction data, and black stripe correction data are stored in the divided region A2.

The B bank includes a divided region B1 with memory addresses “8000h” to “AFFFh”, and a divided region B2 with memory addresses “B000h” to “FFFFh”. Basic correction data and black stripe correction data are stored in the divided region B1. Second extended correction data in which a light amount correction value for each light emitting element is different to the basic correction data, and black stripe correction data are stored in the divided region B2.

According to the present embodiment, common black stripe correction data is stored in the divided region A1 of the A bank and the divided regions B1 and B2 of the B bank.

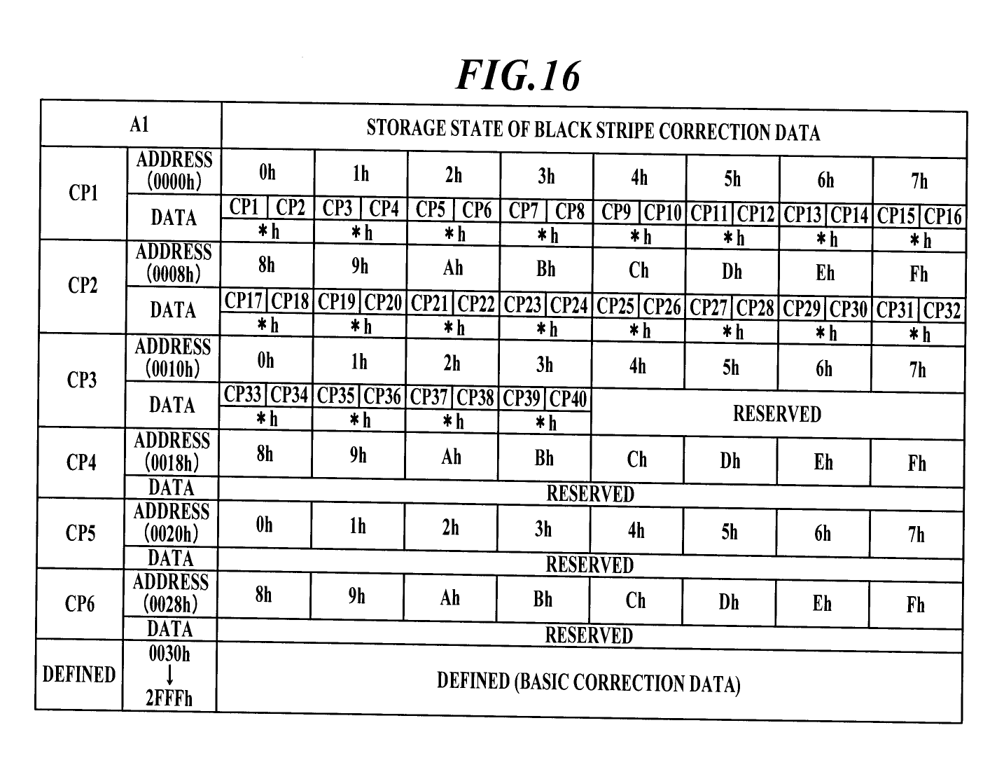

FIG. 16 illustrates an example of a format of data stored in the divided region A1 of the A bank.

As shown in FIG. 16, basic correction data as well as data (CP1 to CP40 in FIG. 16) that indicates a black stripe correction data storage state of each four bits that indicates the presence or absence of black stripe correction data with respect to each predetermined segment when the maximum value list is generated are stored in the divided region A1.

When the value of a predetermined segment of black stripe correction data storage information is 0, it can be determined that there is no black stripe correction data in the predetermined segment in question.

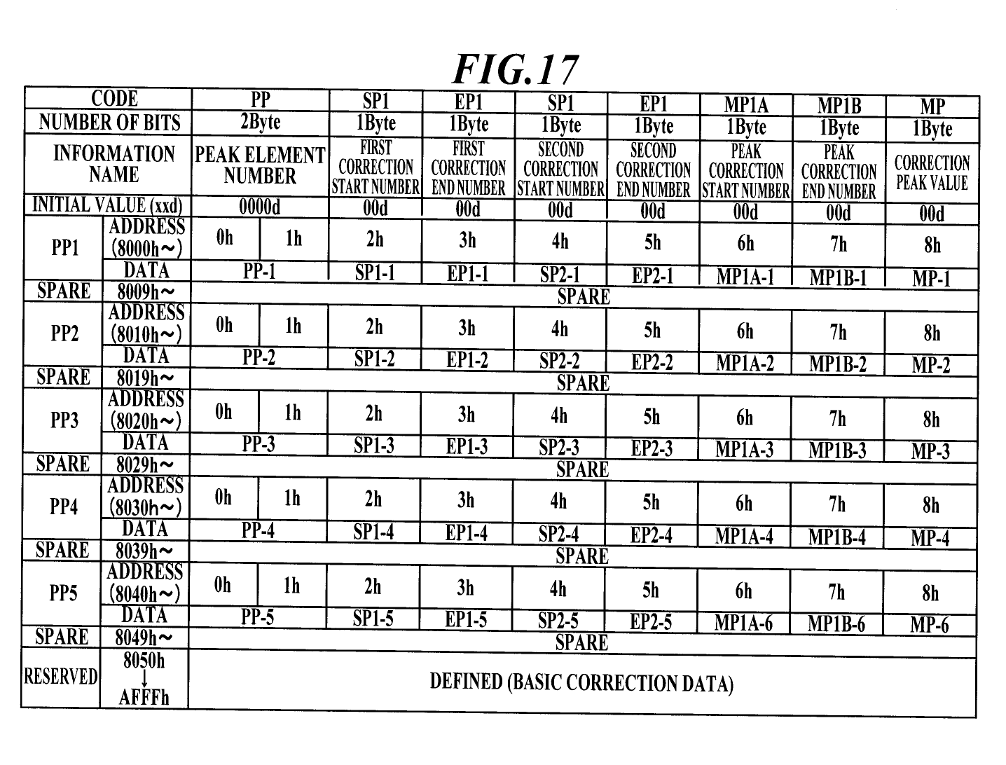

FIG. 17 illustrates an example of a format of data stored in the divided region B1 of the B bank.

As shown in FIG. 17, a maximum of five items of black stripe correction data (PP1 to PP5) and basic correction data are stored in the divided region B1. Each item of black stripe correction data is in 9-byte format.

The respective items of black stripe correction data are stored in small-value order or large-value order with respect to the peak element number PP, or are stored in small-value order or large-value order with respect to the correction peak value.

As shown in FIG. 17, for each item of black stripe correction data, the peak element number PP, first correction start number SP1, first correction end number EP1, second correction start number SP2, second correction end number EP2, peak correction start number MP1A, peak correction end number MP1B, and correction peak value MP are stored by allocating a region of one byte to each single address from the upper address (the peak element number PP is a region of two bytes comprising two addresses from the upper address).

The data of the peak element number PP, the first correction start number SP1, the first correction end number EP1, the second correction start number SP2, the second correction end number EP2, the peak correction start number MP1A, the peak correction end number MP1B, and the correction peak value MP is managed with decimal numbers.

When there is no correction peak value MP, “77h” is stored as the data of the correction peak value MP.

An example of the format of data stored in the divided region A2 of the A bank and the divided region B2 of the B bank is the same as that in which the basic correction data of the data format shown in FIG. 17 is replaced by the first extended correction data and the second extended correction data.

Next, processing that is executed with the image forming apparatus 2 will be described.

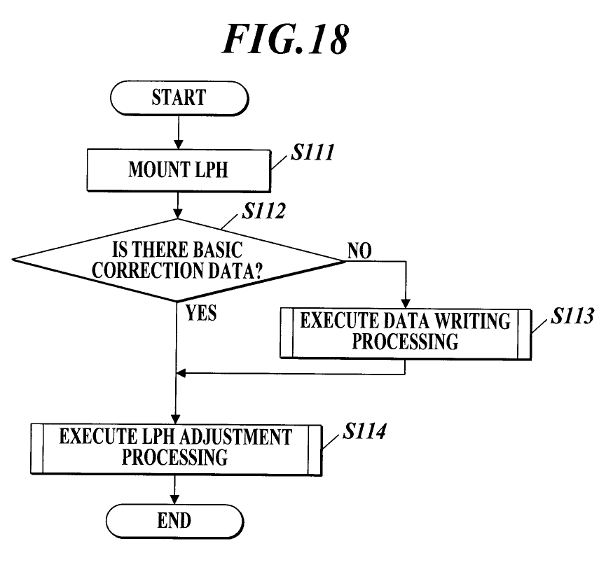

FIG. 18 illustrates a flowchart of LPH assembly processing according to the present embodiment.

The processing shown in FIG. 18 is executed using the image forming apparatus 2.

The LPH 3 for which the LPH inspection processing by the LPH inspection system 1 is completed is mounted to a predetermined position of the image forming apparatus 2 (step S111). The image forming apparatus 2 to which the LPH 3 is mounted determines whether or not there is basic correction data in the storage section 31 of the LPH 3 (step S112).

When there is no basic correction data in the mounted LPH 3 (No in step S112), the image forming apparatus 2 communicates with the LPH inspection system 1 to execute data writing processing that writes basic correction data and the like in the storage section 31 (step S113).

When there is basic correction data in the mounted LPH 3 (Yes in step S112), or after step S113, the image forming apparatus 2 executes LPH adjustment processing using the LPH 3 (step S114), and ends the LPH assembly processing.

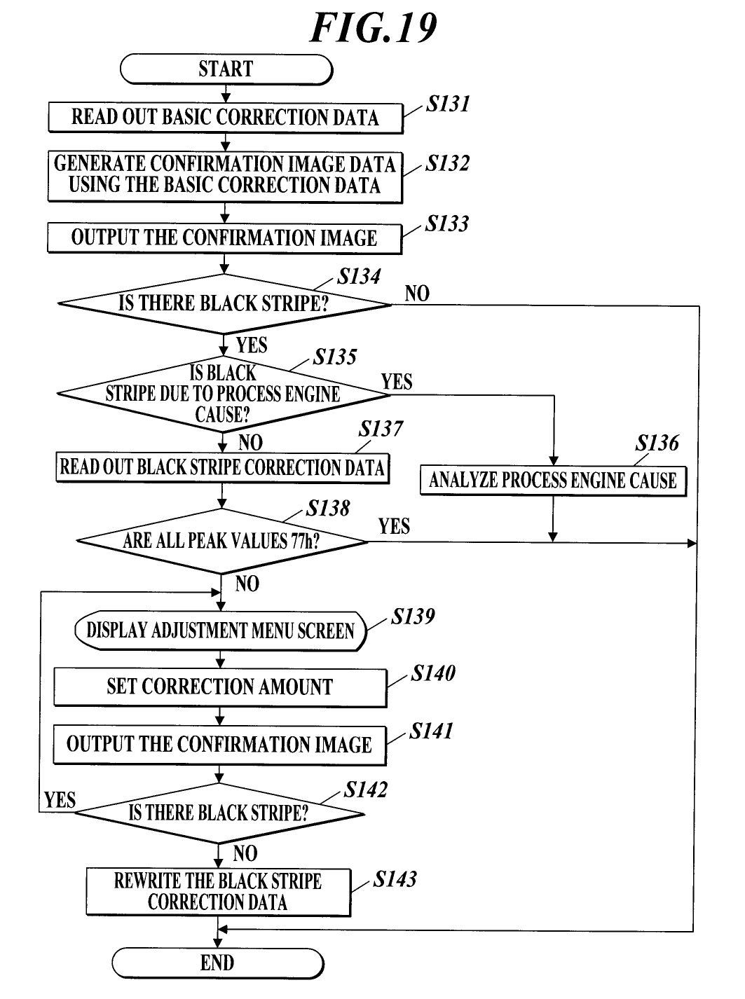

FIG. 19 illustrates a flowchart of LPH adjustment processing according to the present embodiment.

The processing shown in FIG. 19 is executed with the image forming apparatus 2. This processing is executed by joint operations between the CPU 21a and the respective sections.

The CPU 21a reads basic correction data from the storage section 31 of the LPH 3 via the I/O 21g (step S131), and stores the basic correction data inside a light amount correction data memory of the main body storage section 21b. In step S131, for example, basic correction data that is stored in the divided region A1 of the A bank of the storage section 31 is read out.

The CPU 21a generates confirmation image data using the basic correction data that is read out in step S131, and outputs the confirmation image data to the image processing section 21e (step S132). Print data is generated by the image processing section 21e based on the confirmation image data, and various signals are output to the LPH 3 based on the print data by the LPH control section 21f.

The LPH 3 drives on the basis of signals input from the LPH control section 21f, and a confirmation image is formed on a sheet by the printing section 4 and output (step S133).

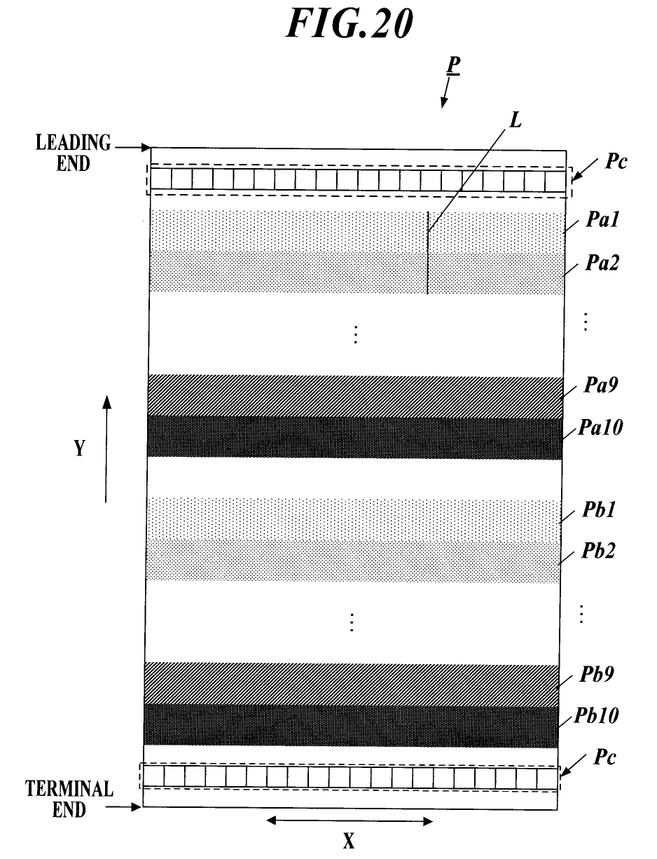

FIG. 20 shows an example of a confirmation image on a sheet.

As shown in FIG. 20, a confirmation image P includes first belt-shaped images Pa1 to Pa10, second belt-shaped images Pb1 to Pb10, and adjustment position images Pc. In the first belt-shaped images Pa1 to Pa10 and the second belt-shaped images Pb1 to Pb10, the screen lines and screen angles are different.

The confirmation image P example shown in FIG. 20 is an example in a case in which a black stripe L has appeared.

The densities of the first belt-shaped images Pa1 to Pa10 are respectively different with regard to adjoining first belt-shaped images in the sub-scanning direction Y. The first belt-shaped images Pa1 to Pa10 are arrayed so that the density of each first belt-shaped image becomes denser or lighter in 10[%] units sequentially in the direction from a leading end to a terminal end in the sub-scanning direction (sheet conveying direction) Y. The detectability at a density of 20 to 50[%] is favorable. Further, preferably the first belt-shaped images Pa1 to Pa10 have 141 lines as screen lines and a screen angle of 45°.

The densities of the second belt-shaped images Pb1 to Pb10 are respectively different with regard to adjoining second belt-shaped images in the sub-scanning direction Y. The second belt-shaped images Pb1 to Pb10 are arrayed so that the density of each second belt-shaped image becomes denser or lighter in 10[%] units sequentially in the direction from the leading end to the terminal end in the sub-scanning direction (sheet conveying direction) Y. The detectability at a density of 20 to 50[%] is favorable. Further, preferably the second belt-shaped images Pb1 to Pb10 have 175 lines as screen lines and a screen angle of 15°.

The adjustment position images Pc are formed by band-shaped images that extend across the main scanning direction X at positions adjacent to both edge parts (leading end part and terminal end part) in the sheet conveying direction Y, and lines that mark off lengths in the main scanning direction of the band-shaped images at previously set intervals (lengths corresponding to predetermined segments of maximum value list). The intervals for marking off the band-shaped images correspond to lengths at which light emitting elements arrayed in the main scanning direction that constitute the LPH 3 are marked off in previously set numerical units. For example, in a case in which, with respect to the light emitting elements, 15,360 pixels are arrayed in the main scanning direction and the light emitting elements are marked off at every 384 elements, lines are formed that mark off the relevant band-shaped image into 40 segments.

Accordingly, the adjustment position images Pc serve as a measure for determining a position in the main scanning direction of a black stripe that appears in the first belt-shaped images or the second belt-shaped images.

An output confirmation image is viewed by a worker that causes the image forming apparatus 2 to execute the present processing, and the worker determines whether or not a black stripe appears on the confirmation image (step S134). If it is determined that a black stripe does not appear on the confirmation image (No in step S134), the determined result is input using the operation display section 23, and the LPH adjustment processing ends. The appearance of a black stripe may also be determined with image analysis means using a scanner.

If a black stripe appears on the confirmation image (Yes in step S134), the worker determines whether or not the appearance of the black stripe is caused by the process engine (step S135). In step S135, the worker determines whether or not the black stripe is caused by the process engine based on the shape of the black stripe. It is known that the width of a black stripe that is not caused by a process engine, that is, a black stripe that appears due to the lens array of the LPH 3, is approximately 1 mm (a length of approximately twice the diameter of an imaging lens). Further, the width of a black stripe that is caused by the process engine is wider than a black stripe caused by a lens array, and is a stripe that is in accordance with a component of the apparatus.

If the appearance of a black stripe is caused by the process engine (Yes in step S135), the determined result is input using the operation display section 23, the process engine cause is analyzed (step S136), and the LPH adjustment processing ends. At this time, it is good to compare black stripe information and an image on the LPH side, and confirm separation of the source of the black stripe with respect to a cause in the process engine. Black stripe information can also be utilized as means for isolating a cause in the process engine.

If the appearance of the black stripe is not caused by the process engine (No in step S135), the determined result is input using the operation display section. When a determination result to the effect that the appearance of a black stripe is not caused by the process engine is input, the CPU 21a reads black stripe correction data stored in the storage section 31 of the LPH 3 (step S137), and stores the data in the light amount correction data memory of the main body storage section 21b. In step S137, for example, black stripe correction data stored in the divided region B1 of the B bank of the storage section 31 is read out.

The CPU 21a determines whether or not the correction peak values MP in the black stripe correction data that is read are all “77h” (step S138). If the correction peak values MP in the black stripe correction data are all “77h” (Yes in step S138), the CPU 21a determines that the black stripe correction data represents adjustment unnecessary information that indicates that there is no data for correcting optical characteristics of the imaging lens, and ends the LPH adjustment processing.

If the result as step S138 is Yes, display of black stripe correction data and acceptance of adjustment instruction information is not performed, and an image can be formed based on the basic correction data.

If the correction peak values MP of the black stripe correction data are not all “77h” (No in step S138), the CPU 21a displays an adjustment menu screen on the operation display section 23 (step S139).

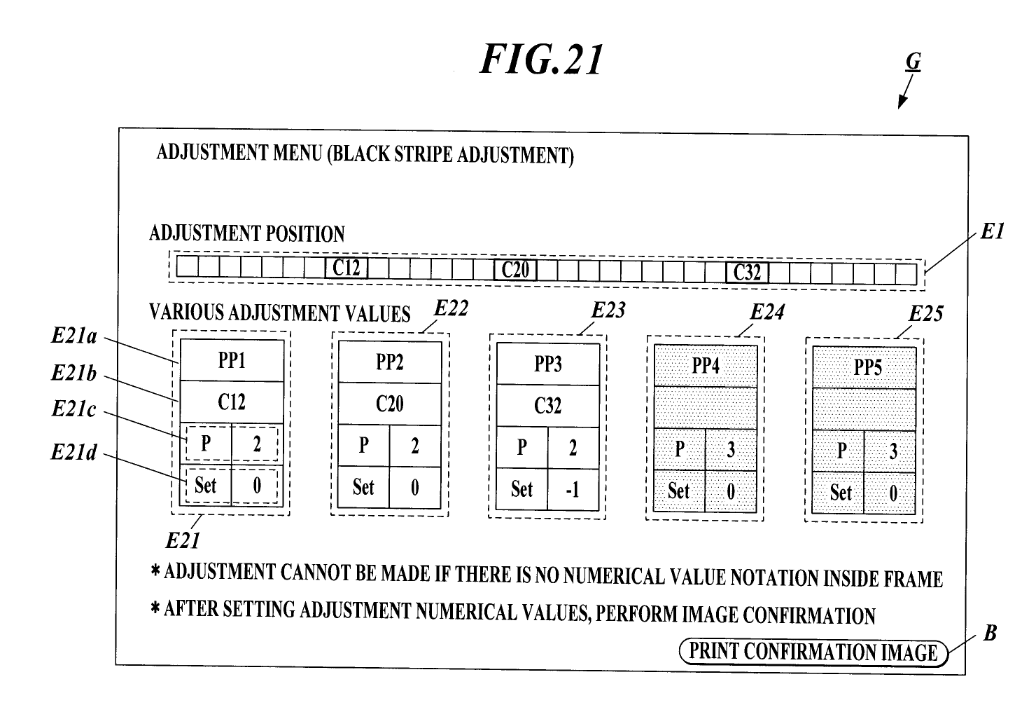

FIG. 21 shows an example of the adjustment menu screen.

As shown in FIG. 21, an adjustment position image region E1, adjustment value setting regions E21 to E25, and a confirmation image print button B are provided on an adjustment menu screen G. The adjustment menu screen G functions as an input section that accepts adjustment instruction information with respect to the black stripe correction data.

In the adjustment position image region E1, an adjustment position image of the same form as the adjustment position image Pc formed in the confirmation image is displayed, and segment numbers of segments of the adjustment position image in which peak element numbers PP of black stripe correction data are included are displayed on the adjustment position image.

In the adjustment value setting region E21, a data number display region E21a, a segment number display region E21b, a correction peak value display region E21c, and an adjustment value display region E21d are provided. The adjustment value setting regions E22 to E25 have the same configuration as the adjustment value setting region E21, and a description thereof is therefore omitted here.

An identification number of black stripe correction data is displayed in the data number display region E21a.

An identification number of the black stripe correction data is assigned when the black stripe correction data is stored in the storage section 31. For example, in FIG. 17 the identification numbers are PP1 to PP5. The segment number of a segment which includes black stripe correction data is shown in the segment number display region E21b. A correction peak value MP of the black stripe correction data is displayed in the correction peak value display region E21c. An adjustment value that changes the correction peak value MP to a value less than or equal to the correction peak value MP in question is displayed in the adjustment value display region E21d.

An adjustment value that is input using ten-keys is accepted as adjustment instruction information by the adjustment menu screen G.

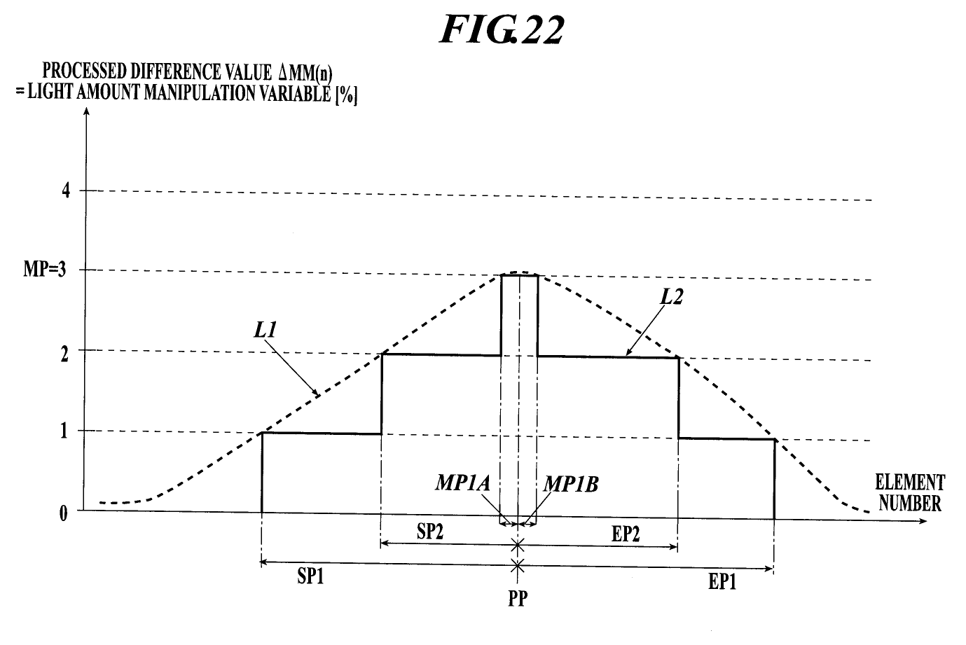

The CPU 21a sets a correction amount that corrects a light amount correction value in accordance with adjustment values of respective items of black stripe correction data input using the adjustment menu screen G (step S140). Setting of the correction amount will now be described referring to FIG. 22.

FIG. 22 illustrates an example of a graph of light amount manipulation variables with respect to each light emitting element.

In the graph shown in FIG. 22, the abscissa axis represents the element number, and the ordinate axis represents the light amount manipulation variable M.

A first curve L1 is a curve that graphs the difference value ΔM(n), and a second curve L2 is a curve that graphs the processed difference value ΔMM(n).

In the graph shown in FIG. 22, the correction peak value MP is 3, the peak element number PP is 14269, the peak correction start number MP1A is 4, the peak correction end number MP1B is 4, the second correction start number SP2 is 32, the second correction end number EP2 is 28, the first correction start number SP1 is 52, and the first correction end number EP1 is 52.

First, a segment in which the light amount manipulation variable is 3 is set.

A segment in which the light amount manipulation variable is the correction peak value MP=3 is a segment from a element number acquired by obtaining a difference between the peak element number PP and the peak correction start number MP1A until a element number obtained by adding the peak correction end number MP1B to the peak element number PP.

In FIG. 22, a segment in which the light amount manipulation variable is 3 is from element number 14265 to 14273.

Next, segments in which the light amount manipulation variable is 2 are set.

Segments in which the light amount manipulation variable is a value (2) obtained by subtracting 1 from the correction peak value MP=3 are a segment from a element number acquired by obtaining a difference between the peak element number PP and the second correction start number SP2 until a element number obtained by subtracting the peak correction start number MP1A from the peak element number PP, and a segment from a element number obtained by adding the peak correction end number MP1B to the peak element number PP until a element number obtained by adding the second correction end number EP2 to the peak element number PP. In FIG. 22, the segments in which the light amount manipulation variable is 2 are from element number 14237 to 14266 and from element number 14274 to 14297.

Next, segments in which the light amount manipulation variable is 1 are set.

Segments in which the light amount manipulation variable is a value (1) obtained by subtracting 2 from the correction peak value MP=3 are a segment from a element number acquired by obtaining a difference between the peak element number PP and the first correction start number SP1 until a element number obtained by subtracting the second correction start number SP2 from the peak element number PP, and a segment from a element number obtained by adding the second correction end number EP2 to the peak element number PP until a element number obtained by adding the first correction end number EP1 to the peak element number PP. In FIG. 22, the segments in which the light amount manipulation variable is 1 are from element number 14217 to 14236 and from element number 14298 to 14321.

After segments of the respective light amount manipulation variables are determined, correction amounts for light amount correction values for the light emitting elements of each correction target segment are set in accordance with the adjustment amounts.

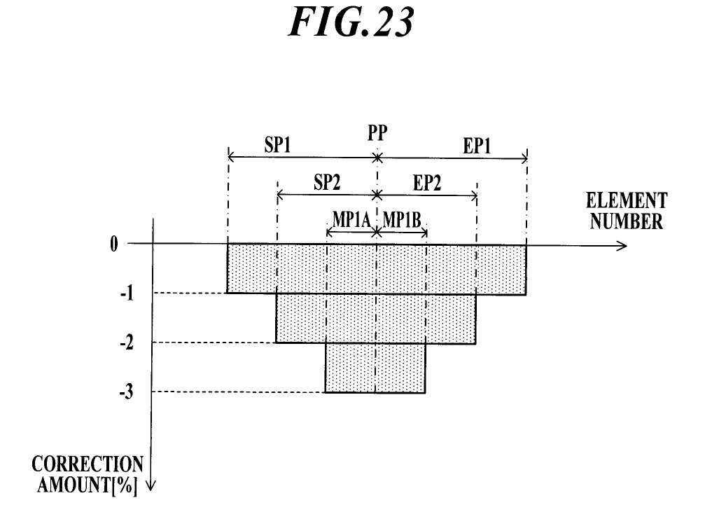

FIG. 23 shows a conceptual illustration of a correction amount when the adjustment amount is 0.

When the adjustment amount is 0, the maximum value of the light amount manipulation variable is the correction peak value MP (3).

A correction amount for the light amount correction value of light emitting elements in a segment (PP-MP1A to PP+MP1B in FIG. 23) in which the light amount manipulation variable is the correction peak value MP (3) is set to −3[%] in accordance with the correction peak value MP, and the light amount correction value of light emitting elements in the relevant segment is corrected to a value obtained by reducing the relevant value by −3[%].

A correction amount for the light amount correction value of light emitting elements in segments (PP-SP2 to PP-MP1A, and PP+MP1B to PP+EP2 in FIG. 23) in which the light amount manipulation variable is next largest after the correction peak value MP, that is to say, segments in which the light amount manipulation variable is 2, is set to −2[%] in accordance with the light amount manipulation variable, and the light amount correction value of light emitting elements in the relevant segments is corrected to a value obtained by reducing the relevant value by −2[%].

A correction amount for the light amount correction value of light emitting elements in segments (PP-SP1 to PP-SP2, and PP+EP2 to PP+EP1 in FIG. 23) in which the light amount manipulation variable is second next largest after the correction peak value MP, that is to say, segments in which the light amount manipulation variable is 1, is set to −1[%] in accordance with the light amount manipulation variable, and the light amount correction value of light emitting elements in the relevant segments is corrected to a value obtained by reducing the relevant value by −1[%].

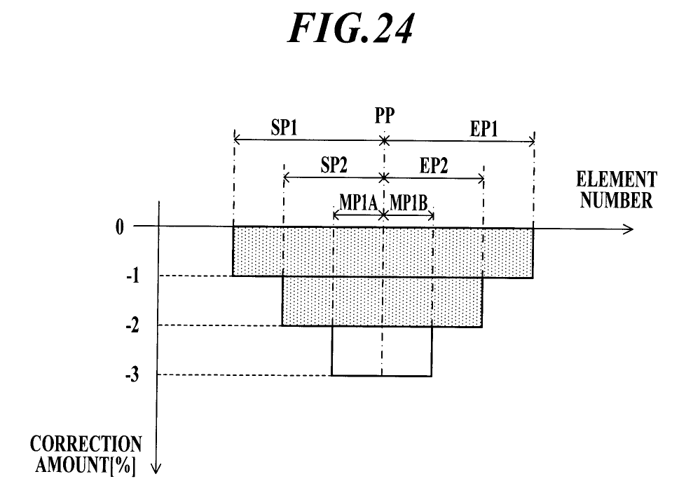

FIG. 24 shows a conceptual illustration of a correction amount when the adjustment amount is −1.

When the adjustment amount is −1, the maximum value of the light amount manipulation variable is a value (2) obtained by subtracting 1 from the correction peak value MP (3).

A correction amount for the light amount correction value of light emitting elements in a segment in which the light amount manipulation variable is the correction peak value MP and segments (PP−SP2 to PP+EP2 in FIG. 24) in which the light amount manipulation variable is next largest after the correction peak value MP, that is to say, segments in which the light amount manipulation variable is 2, is set to −2[%] in accordance with the correction peak value MP that is adjusted by the adjustment amount, and the light amount correction value of light emitting elements in the relevant segments is corrected to a value obtained by reducing the relevant value by −2[%].

Specifically, as shown in FIG. 24, when the adjustment amount is set to −1 when the correction peak value MP is 3, the correction peak value MP is not applied for the correction amount of the segment (PP−MP1A to PP+MP1B in FIG. 24) of the correction peak value MP, and a value is applied that is obtained by subtracting the adjustment amount from the correction peak value MP.

A correction amount for the light amount correction value of light emitting elements in segments (PP−SP1 to PP−SP2, and PP+EP2 to PP+EP1 in FIG. 24) in which the light amount manipulation variable is second next largest after the correction peak value MP, that is to say, segments in which the light amount manipulation variable is 1, is set to −1[%] in accordance with the light amount manipulation variable, and the light amount correction value of light emitting elements in the relevant segments is corrected to a value obtained by reducing the relevant value by −1[%].

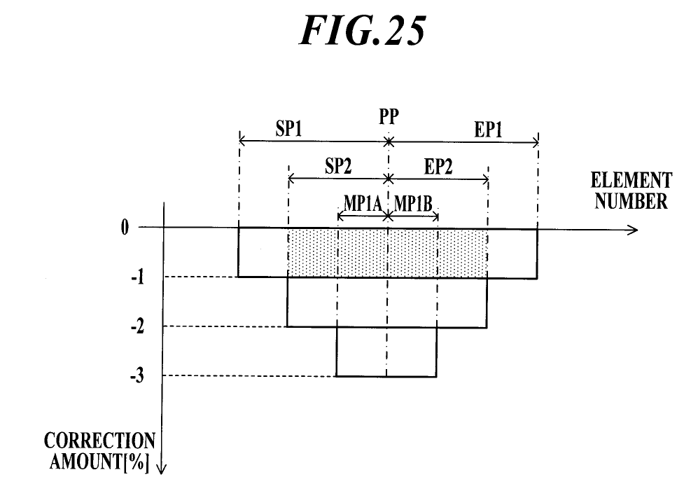

FIG. 25 shows a conceptual illustration of a correction amount when the adjustment amount is −2.

When the adjustment amount is −2, the maximum value of the light amount manipulation variable is a value (1) obtained by subtracting 2 from the correction peak value MP (3).

A correction amount for the light amount correction value of light emitting elements in a segment in which the light amount manipulation variable is the correction peak value MP and segments (PP−SP2 to PP+EP2 in FIG. 25) in which the light amount manipulation variable is next largest after the correction peak value MP, that is to say, segments in which the light amount manipulation variable is 2, is set to −1[%] in accordance with the correction peak value MP that is adjusted by the adjustment amount, and the light amount correction value of light emitting elements in the relevant segments is corrected to a value obtained by reducing the relevant value by −1[%].

Specifically, as shown in FIG. 25, when the adjustment amount is set to −2 when the correction peak value MP is 3, the correction peak value MP is not applied for the correction amount of the segment (PP−MP1A to PP+MP1B in FIG. 25) of the correction peak value MP, and a value is applied that is obtained by subtracting the adjustment amount from the correction peak value MP. Further, as the correction amount of segments (PP−SP2 to PP−MP1A and PP+MP1B to PP+EP2 in FIG. 25) in which the light amount manipulation variable is next largest after the correction peak value MP, a value of the light amount manipulation variable of the relevant segments is not applied, and a value is applied that is obtained by subtracting the adjustment amount from the correction peak value MP.

A correction amount for the light amount correction value of light emitting elements in segments (PP-SP1 to PP-SP2 and PP+EP2 to PP+EP2 in FIG. 24) in which the light amount manipulation variable is second next largest after the correction peak value MP, that is to say, in segments in which the light amount manipulation variable is 1, is set to 0[%], and the light amount correction value of light emitting elements in the segments in question is not corrected.

When an adjustment value is input such that a sum of the correction peak value and the adjustment value is 0, it means that an instruction to the effect that adjustment of a light amount correction value of basic correction data using black stripe correction data will not be performed has been input. That is to say, when the correction peak value MP is 3 and the adjustment value is −3, the maximum value of the light amount manipulation variable will be a value (0) obtained by subtracting 3 from the correction peak value MP (3), and a correction amount for a light amount correction value of the light emitting elements will be set to 0[%]. Hence, the light amount correction value of the light emitting elements is not corrected.

Thus, based on the black stripe correction data and the adjustment value, the CPU 21a sets a correction amount that adjusts the light amount correction value of light emitting elements included in segments indicated by the black stripe correction data, and corrects the light amount correction value of the light emitting elements of each segment in accordance with the correction amount.

After setting the correction amount (after step S140), the CPU 21a corrects the light amount correction value of light emitting elements in the segments of the black stripe correction data based on the correction amount that has been set. The CPU 21a rewrites the basic correction data stored in the main body storage section 21b with corrected light amount correction values of the segments of the black stripe correction data and light amount correction values of basic correction data of other segments excluding the segments of black stripe correction data. The CPU 21a generates confirmation image data based on basic correction data stored in the main body storage section 21b, and outputs the confirmation image data to the image processing section 21e.

Print data is generated based on the confirmation image data by the image processing section 21e, and various signals based on the print data are output to the LPH 3 by the LPH control section 21f. Subsequently, the LPH 3 drives on the basis of the signals input from the LPH control section 21f, and a confirmation image is formed on a sheet and output by the printing section 4 (step S141).

The output confirmation image is viewed by a worker, and the worker determines whether or not a black stripe appears on the confirmation image (step S142). If a black stripe appears on the confirmation image (Yes in step S142), the determined result is input using the operation display section 23, and the CPU 21a returns to the processing of step S139. The presence of a black stripe may also be determined with image analysis means using a scanner.

If a black stripe does not appear on the confirmation image (No in step S142), the determined result is input using the operation display section 23, the CPU 21a rewrites black stripe correction data that has been adjusted in accordance with the input adjustment value in the storage section 31 constituting the LPH 3 (step S143), and ends the LPH adjustment processing. In step S143, the black stripe correction data stored in the storage section 31 is rewritten with black stripe correction data indicating correction amounts that are set in accordance with the adjustment value.

According to the present embodiment as described above, the LPH 3 includes the storage section 31 that stores basic correction data for correcting the amounts of light of the light emitting elements as well as black stripe correction data that is based on MTF data specific to the imaging lenses. With this feature, it is possible to identify a position of a black stripe that appears on an image due to the imaging lenses constituting the LPH 3, and to correct an amount of light with respect to the position of the black stripe and thereby enhance the image quality.

In particular, the position of a black stripe can be identified by the peak element number PP and the number of elements from the peak element number PP to one end and another end of a segment for each light amount manipulation variable (peak correction start number MP1A, peak correction end number MP1B, first correction start number SP1, first correction end number EP1, second correction start number SP2, and second correction end number EP2). Further, light amount correction can be performed with respect to a light emitting element at the position of the black stripe in question by means of the correction peak value MP.

Furthermore, it is possible to correct a light amount correction position for correcting the amounts of light of light emitting elements, respectively, based on black stripe correction data that is based on MTF data specific to the imaging lenses. Hence, the position of a black stripe that appears on an image that is caused by imaging lenses comprising the LPH 3 can be identified, light amount correction can be performed for the position of the black stripe, and thus the image quality can be improved.

Further, since black stripe correction data can be adjusted based on adjustment instruction information (adjustment value) accepted by the adjustment menu screen G, it is possible to realize an image that possesses the image quality desired by the user.

Further, black stripe correction data can be calculated based on MTF data specific to the imaging lenses and written in the storage section 31 of the LPH 3. Hence, when forming an image using the LPH 3, the position of a black stripe that appears on an image caused by imaging lenses constituting the optical writing apparatus can be identified, light amount correction can be performed with respect to the position of the black stripe, and thus the image quality can be improved.

Furthermore, black stripe correction data stored in the storage section 31 of the LPH 3 can be rewritten with black stripe correction data that has been adjusted based on correction instruction information (adjustment value) input from the adjustment menu screen.

In the above description, the memory 17b and the main body storage section 21b have been presented as a computer-readable medium embodying a program according to the embodiments of the present invention. A nonvolatile memory such as a flash memory and a removable medium such as a CD-ROM may be employed as another computer-readable medium. Moreover, a carrier wave may be used as a medium that provides program data related to the embodiments disclosed herein via communication lines.

The present invention is not to be considered limited to what is shown in the above-described embodiments. It will be obvious to those skilled in the art that various changes may be made without departing from the scope of the invention.

According to a first aspect of the preferred embodiments of the present invention, there is provided an optical writing apparatus which includes: a light source section having a plurality of light emitting elements arrayed in a main scanning direction; an optical section having a plurality of imaging lenses that condense irradiated light from the light emitting elements to form an image on an exposure surface; and a storage section. The storage section stores: first correction data including light amount correction values for correcting amounts of light of the respective light emitting elements; and second correction data. The second correction data includes: local correction target position information in an array direction of the light emitting elements that is calculated based on optical characteristics data specific to the imaging lenses; and a correction reference value for correcting one or more of the light amount correction values of one or more of the light emitting elements arrayed at local positions indicated by the correction target position information.

As described above, the optical writing apparatus includes the storage section which stores the first correction data for correcting the amounts of light of the light emitting elements, and the second correction data based on the optical characteristics data specific to the imaging lenses. With this feature, it is possible to specify a position of a black stripe which appears on an image due to the imaging lenses constituting the optical writing apparatus, and to correct an amount of light with respect to the position of the black stripe to improve image quality.

The optical characteristics data may be MTF data calculated based on data of amount of light detected in the irradiated light that has transmitted the optical section.

Thus the MTF data may be used as the optical characteristics data.

The correction target position information may indicate segment information showing a segment in which the one or more of the light emitting elements that the optical characteristics data changes locally are arrayed.

The position of the black stripe can be specified by the segment information showing a segment in which the one or more of the light emitting elements that the optical characteristics data changes locally are arrayed.

The correction reference value may be a maximum of values calculated based on the optical characteristics data among the one or more of the light emitting elements in the segment. The segment information may include: a maximum element number indicating an identification number of one of the light emitting elements that a value of the optical characteristics data corresponds to the maximum of values; and the number of elements from the maximum element number to one end of the segment and to the other end of the segment.

With this feature, the position of the black stripe can be specified by: the maximum element number that the value of the optical characteristics data corresponds to the maximum of values; and the number of elements from the maximum element number to one end of the segment and to the other end of the segment. The amount of light of the light emitting element at the position of the black stripe can be corrected based on the maximum of values.

The storage section may store a plurality of pieces of the second correction data in an ascending order or a descending order of the maximum element number.

Thus the plurality of pieces of the second correction data can be stored in an ascending order or a descending order of the maximum element number.

The storage section may store a plurality of pieces of the second correction data in an ascending order or a descending order of the maximum of values.

Thus the plurality of pieces of the second correction data can be stored in an ascending order or a descending order of the maximum of values.

According to a second aspect of the preferred embodiments of the present invention, there is provided an image forming apparatus that forms an image using the optical writing apparatus. The image forming apparatus includes: a control section to read out the first correction data and the second correction data from the storage section of the optical writing apparatus to correct the first correction data based on the second correction data; and a main body storage section to store the first correction data corrected by the control section.

With respect to the image forming apparatus, it goes without saying that the same advantageous effects as those of the optical writing apparatus can be achieved. In addition, the first correction data for correcting the amounts of light of the light emitting elements can be corrected according to the second correction data based on the optical characteristics data specific to the imaging lenses. With this feature, it is possible to specify a position of a black stripe which appears on an image due to the imaging lenses constituting the optical writing apparatus, and to correct an amount of light with respect to the position of the black stripe to improve image quality.

The image forming apparatus may further include an input section to accept adjustment instruction information with respect to the second correction data. The control section may: adjust the second correction data based on the adjustment instruction information input from the input section to produce adjusted second correction data; correct the first correction data based on the adjusted second correction data to produce corrected first correction data; and rewrite the first correction data stored in the main body storage section with the corrected first correction data.

Thus the second correction data can be adjusted based on the adjustment instruction information input from the input section.

The image forming apparatus may further include an input section to accept adjustment instruction information with respect to the second correction data. The control section may: adjust the second correction data based on the adjustment instruction information input from the input section to produce adjusted second correction data; and rewrite the second correction data stored in the storage section of the optical writing apparatus with the adjusted second correction data.

Thus the second correction data stored in the storage section of the optical writing apparatus can be rewritten with the adjusted second correction data.

According to a third aspect of the preferred embodiments of the present invention, there is provided a data writing method in a system which includes an optical writing apparatus and a control apparatus. The optical writing apparatus includes: a light source section having a plurality of light emitting elements arrayed in a main scanning direction; an optical section having a plurality of imaging lenses that condense irradiated light from the light emitting elements to form an image on an exposure surface; and a storage section. The control apparatus writes data on the storage section of the optical writing apparatus. The data writing method includes: measuring optical characteristics data specific to the imaging lenses; calculating correction data based on the optical characteristics data, the correction data including a correction reference value and local correction target position information in an array direction of the light emitting elements; and writing the correction data on the storage section.

Thus the correction data can be calculated based on the optical characteristics data specific to the imaging lenses, and the correction data can be written on the storage section of the optical writing apparatus. With this feature, it is possible to specify a position of a black stripe which appears on an image due to the imaging lenses constituting the optical writing apparatus, and to correct an amount of light with respect to the position of the black stripe to improve image quality, when forming the image using the optical writing apparatus.

The present U.S. patent application claims a priority under the Paris Convention of Japanese patent application No. 2009-020003 filed on Jan. 30, 2009 which shall be a basis of correction of an incorrect translation.

What is claimed is:

1. An optical writing apparatus, comprising:
a light source section having a plurality of light emitting elements arrayed in a main scanning direction;
an optical section having a plurality of imaging lenses that condense irradiated light from the light emitting elements to form an image on an exposure surface; and
a storage section to store:
first correction data including light amount correction values for correcting amounts of light of the respective light emitting elements; and
second correction data including:
local correction target position information in an array direction of the light emitting elements that is calculated based on optical characteristics data specific to the imaging lenses; and
a correction reference value for correcting one or more of the light amount correction values of one or more of the light emitting elements arrayed at local positions indicated by the correction target position information.

2. The optical writing apparatus of claim 1, wherein
the optical characteristics data is MTF data calculated based on data of amount of light detected in the irradiated light that has transmitted the optical section.

3. The optical writing apparatus of claim 1, wherein
the correction target position information indicates segment information showing a segment in which the one or more of the light emitting elements that the optical characteristics data changes locally are arrayed.

4. The optical writing apparatus of claim 3, wherein
the correction reference value is a maximum of values calculated based on the optical characteristics data among the one or more of the light emitting elements in the segment, and
the segment information includes:
a maximum element number indicating an identification number of one of the light emitting elements that a value of the optical characteristics data corresponds to the maximum of values; and
the number of elements from the maximum element number to one end of the segment and to the other end of the segment.

5. The optical writing apparatus of claim 4, wherein
the storage section stores a plurality of pieces of the second correction data in an ascending order or a descending order of the maximum element number.

6. The optical writing apparatus of claim 4, wherein
the storage section stores a plurality of pieces of the second correction data in an ascending order or a descending order of the maximum of values.

7. An image forming apparatus that forms an image using the optical writing apparatus of claim 1, comprising:
a control section to read out the first correction data and the second correction data from the storage section of the optical writing apparatus to correct the first correction data based on the second correction data; and
a main body storage section to store the first correction data corrected by the control section.

8. The image forming apparatus of claim 7, further comprising an input section to accept adjustment instruction information with respect to the second correction data, wherein
the control section adjusts the second correction data based on the adjustment instruction information input from the input section to produce adjusted second correction data, corrects the first correction data based on the adjusted second correction data to produce corrected first correction data, and rewrites the first correction data stored in the main body storage section with the corrected first correction data.

9. The image forming apparatus of claim 7, further comprising an input section to accept adjustment instruction information with respect to the second correction data, wherein
the control section adjusts the second correction data based on the adjustment instruction information input from the input section to produce adjusted second correction data, and rewrites the second correction data stored in the storage section of the optical writing apparatus with the adjusted second correction data.

10. A data writing method in a system which comprises:
an optical writing apparatus, including:
a light source section having a plurality of light emitting elements arrayed in a main scanning direction;
an optical section having a plurality of imaging lenses that condense irradiated light from the light emitting elements to form an image on an exposure surface; and
a storage section; and
a control apparatus to write data on the storage section of the optical writing apparatus,
the method comprising:
measuring optical characteristics data specific to the imaging lenses;
calculating correction data based on the optical characteristics data, the correction data including a correction reference value and local correction target position information in an array direction of the light emitting elements; and
writing the correction data on the storage section.

11. The data writing method of claim 10, wherein
the optical characteristics data is MTF data calculated based on data of amount of light detected in the irradiated light that has transmitted the optical section.

12. The data writing method of claim 10, wherein
the correction target position information indicates segment information showing a segment in which the one or more of the light emitting elements that the optical characteristics data changes locally are arrayed.

13. The data writing method of claim 12, wherein
the correction reference value is a maximum of values calculated based on the optical characteristics data among the one or more of the light emitting elements in the segment, and
the segment information includes:
a maximum element number indicating an identification number of one of the light emitting elements that a value of the optical characteristics data corresponds to the maximum of values; and
the number of elements from the maximum element number to one end of the segment and to the other end of the segment.

14. The data writing method of claim 13, wherein
a plurality of pieces of the correction data are stored in the storage section in an ascending order or a descending order of the maximum element number.

15. The optical writing apparatus of claim 13, wherein
a plurality of pieces of the correction data are stored in the storage section in an ascending order or a descending order of the maximum of values.
